(19) United States
(12) Patent Application Publication
(10) Pub. No.: US 2007/0214133 A1
(43) Pub. Date: Sep. 13, 2007

(54) Methods for filtering data and filling in missing data using nonlinear inference

(76) Inventors: Edo Liberty, New Haven, CT (US); Steven Zucker, Hamden, CT (US); Yosi Keller, Rohovot (IL); Mauro M. Maggioni, Durham, NC (US); Ronald R. Coifman, North Haven, CT (US); Frank Geshwind, Madison, CT (US)

Correspondence Address: FULBRIGHT & JAWORSKI, LLP, 666 FIFTH AVE, NEW YORK, NY, 10103-3198, US

(21) Appl. No.: 11/715,863

(22) Filed: Mar. 7, 2007

Related U.S. Application Data
(63) Continuation-in-part of application No. 11/230,949, filed on Sep. 19, 2005.
(63) Continuation-in-part of application No. 11/230,949, filed on Sep. 19, 2005.
(63) Continuation-in-part of application No. 11/165,633, filed on Jun. 23, 2005.
(60) Provisional application No. 60/779,958, filed on Mar. 7, 2006.
(60) Provisional application No. 60/610,841, filed on Sep. 17, 2004.
(60) Provisional application No. 60/697,069, filed on Jul. 5, 2005.
(60) Provisional application No. 60/582,242, filed on Jun. 23, 2004.

(51) Int. Cl. G06F 17/30

(52) U.S. Cl. 707/5

(57) ABSTRACT

The present invention is directed to a method for inferring/estimating missing values in a data matrix d(q, r) having a plurality of rows and columns comprises the steps of: organizing the columns of the data matrix d(q, r) into affinity folders of columns with similar data profile, organizing the rows of the data matrix d(q, r) into affinity folders of rows with similar data profile, forming a graph Q of augmented rows and a graph R of augmented columns by similarity or correlation of common entries; and expanding the data matrix d(q, r) in terms of an orthogonal basis of a graph Q×R to infer/estimate the missing values in said data matrix d(q, r) on the diffusion geometry coordinates.

### RELATED APPLICATION

This application claims priority benefit under Title 35 U.S.C. §119(e) of U.S. Provisional Patent Application No. 60/779,958, filed Mar. 7, 2006, which is incorporated by reference in its entirety. Also, this application is continuation-in-part of U.S. application Ser. No. 11/230,949, filed Sep. 19, 2005, which claims priority benefit under Title 35 U.S.C. §119(e) of provisional patent application No. 60/610,841 filed Sep. 17, 2004 and provisional patent application No. 60/697,069 filed Jul. 5, 2005, each which is incorporated by reference in its entirety. Also, this application is a continuation-in-part of U.S. patent application Ser. No. 11/165,633 filed Jun. 23, 2005, which claims priority benefit under Title 35 U.S.C. §119(e) of provisional patent application No. 60/582,242 filed Jun. 23, 2004, each which is incorporated by reference in its entirety.

### BACKGROUND OF THE INVENTION

The present invention relates generally to data denoising, robust empirical functional regression, interpolation and extrapolation, and more specifically in some aspects to filling in missing data using nonlinear inference. Common challenges encountered in information processing and knowledge extraction tasks involve corrupt data, either noisy or with missing entries. Some embodiments of the present invention make efficient use of the network of inferences and similarities between the data points to create robust nonlinear estimators for missing entries.

Also, the present invention relates generally to database searching, data organization, information extraction, and data features extraction. More particularly, the present invention relates to personalized search of databases including intranets and the Internet, and to mathematically motivated techniques for efficiently empirically discovering useful metric structures in high-dimensional data, and for the computationally efficient exploitation of such structures. The methods disclosed relate as well to improvement of information retrieval processes generally, by providing methods of augmenting these processes with additional information that refines the scope of the information to be retrieved.

Search terms have different meanings in different contexts. Prior art search engines, such as Google, typically use a single method of interpretation and scoring of search results. Thus, in Google for example, the most popular meaning of a particular search term will end up being prioritized over alternate, less popular, meanings. However, often the user really intends to search for the alternate meaning(s). For example, the search query term “gates” may mean “logic gates”, “Bill Gates”, “wrought-iron gates”, etc. In each case, the addition of extra keywords could serve to disambiguate the search query. However, often a user does not realize that these extra terms are needed, or otherwise does not wish to put in the time or effort perfecting the search query.

Consequently there is a need for a personalized search engine technology capable of augmenting a first search query, based on some additional knowledge about the intention of the user. More generally, there is a need for information retrieval technology that factors in additional knowledge to return improved results.

The term “data mining” as used herein broadly refers to the methods of data organization and subset and feature extraction. Furthermore, the kinds of data described or used in data mining are referred to as (sets of) “digital documents.” Note that this phrase is used for conceptual illustration only, can refer to any type of data, and is not meant to imply that the data in question are necessarily formally documents, nor that the data in question are necessarily digital data. The “digital documents” in the traditional sense of the phrase are certainly interesting examples of the kinds of data that are addressed herein.

### OBJECTS AND SUMMARY OF THE INVENTION

The present system and method described are herein applicable at least in the case in which, as is typical, the given data to be analyzed can be thought of as a collection of data objects, and for which there is some at least rudimentary notion of what it means for two data objects to be similar, close to each other, or nearby.

The present invention relates to methods for organization of data, and extraction of information, subsets and other features of data, and to techniques for efficient computation with said organized data and features. More specifically, the present invention relates to mathematically motivated techniques for efficiently empirically discovering useful metric structures in high-dimensional data, and for the computationally efficient exploitation of such structures.

It is an object of the present invention to automatically augment search queries, modeling the intended context of a given search query by using prior knowledge about the user of the search and/or the context of the search. As in the example above, the search term “gates” could be rewritten for a CMOS technologist as “logic gates OR CMOS gates”, while it could be rewritten as “Bill Gates” for an operating system software business pundit, and “iron gates” for a wrought-iron specialist. For users with multiple interests, several forms could be used.

It is an object of the present invention to augment a first search query with extra search terms and Boolean logic, based on the first query as well as some additional knowledge about the intention of the user including but not limited to user preferences, interests, prior search choices, bookmarks, emails, files, web sites and blogs read or frequented by the user, etc. This augmentation can then be used to construct a second search query; the augmented query.

It is an object of the present invention to use statistical aspects of one or more relevant corpora of documents, in part, to define the interests of a user or class of users. For example, to apply the present invention to the augmentation of search queries to specifically search for results relevant for baseball enthusiasts, a corpus of documents may be used that consists of baseball news articles, baseball encyclopedia entries, baseball website content & blogs, and the like.

It is an object of the present invention to use statistical aspects of the interaction between a first search query and the one or more relevant corpora of documents, to define one or more second search queries. For example, suppose that in a baseball specific corpus, those documents that contain the query word “positions” are much more likely than average to also contain the associated terms “first base”, “second base”, “third base”, “shortstop”, “outfield”, “pitcher”, “catcher”, etc. Then an embodiment of the present invention can, for example, given as input the query word, produce a second search query that is made from the query word, with the addition of the associated terms, and some Boolean connectors. For example, “positions” can become: “positions AND (‘first base’ OR ‘second base’ OR ‘third base’ OR ‘shortstop’ OR ‘outfield’ OR ‘pitcher’ OR ‘catcher’)”.

In this regard, an embodiment of the present invention comprises a search query rewriting system which takes as input a first query. The first query is used to run a first search on a first corpus of documents, returning a first subset of documents in response to the first search. Word frequency statistics are computed for the first subset of documents. These statistics are compared with the corresponding word frequency statistics for the corpus as a whole, or for the language as a whole. Resultant words are identified for which the difference between the word's frequency in the first subset of documents, as compared with the corresponding whole-corpus or whole-language frequencies, is largest (e.g. above a given threshold, or, say, the 5 largest). A second query is formed consisting of the first query, Boolean connectors, and the resultant words. (e.g. <first query> AND word1 OR word2 OR . . . OR word5). A second search is then run on a second one or more corpora of documents, for example on the Internet. The second search is a search for documents that match the second query. The results of the second search are returned to the user.

One of skill in the art will readily see that while the present invention is disclosed in terms of search query rewriting, the techniques disclosed relate more generally to the improvement of information retrieval processes. To this end, in some aspects it is object of the present invention to improve information retrieval processes generally, by providing methods of augmenting the processes with additional information that refines the scope of the information to be retrieved. Generally these statistical information about one or more corpora of data elements, and the interaction between a first data retrieval specification and the one or more relevant corpora of data elements, is used to define one or more second data retrieval specifications. The second data retrieval specifications are used to retrieve information of a more relevant scope, from a second one or more corpora of data elements. We sometimes refer broadly to the class of embodiments described in this paragraph as fr_matr_bin-type. This name comes from the name of a particular set of algorithms within the broad class, but the term “fr_matr_bin-type” is meant to refer to this general class of embodiments just described.

In this regard, an embodiment of the present invention comprises a search by example system. For illustration, we will consider such a system working on a set of datapoints in a high-dimensional space. More specifically, we will use as an example the problem of music similarity “search by example”. In such embodiment, a search engine is disposed to search through a corpus of digital music files. For each file, the system has pre-computed a set of numerical coordinates that characterize various standard aspects of the file. In this way the embodiment can treat the corpus of data as a set of points in a high dimensional space. Such characteristic numerical coordinates are known to those of skill in the art, and include, but are not limited to, timberal Fourier, MERL and cepstral coefficients, Hidden Markov Model parameters, dynamic range vs. time parameters, etc. In an exemplary query by example interface, a user specifies a few music files from the corpus of digital music files. The embodiment then characterizes the coordinates of the subset of points associated with the specified few music files, and selects a region or set of directions in the high dimensional space that are characteristic of the contrast between the subset of points, and the full set of points corresponding to the whole corpus. The embodiment then selects those other points that are also within or near the region, or are also disposed along the directions in the high dimensional space, and the music files (or, e.g., a list of pointers or indexes thereto) corresponding to the data points are returned as the results of the improved “query by example”. It should be noted that in order to carry out the steps described, one needs only a statistical characterization of the large set of points to be searched, as well as set of points given as examples. Hence it will be readily seen by one skilled in the art that it is not necessary to characterize every music file individually, in order to use the disclosed method to improve information retrieval processes.

The fr_matr_bin-type embodiments relate in part to methods for finding objects that have similarity or affinity to some other target objects or search query results. In accordance with an embodiment of the present invention, diffusion geometries also relate in part to methods for finding similarity or affinity between objects. In this regard, elements disclosed herein relating to the use of fr_matr_bin-type embodiments on the one hand, and on the other hand elements disclosed herein relating to the use of diffusion geometry, can be interchanged.

In accordance with an embodiment of the present invention (see FIG. 1), corpora (5) and (9) of data is used to add meaning to the query. Hence, it is only necessary that corpora (5) and (9) be a “rich enough” statistical sample of the full set of documents (i.e., music files). It is appreciated that this “rich enough” statistical sample can be accomplished in a number of ways standard in the art. For example, the statistical sample can be obtained iteratively by trying a small subset, collecting and storing the results of a number of typical/popular queries, and then adding more documents at random and performing the same typical/popular queries. If the results are roughly the same, then stop adding more documents. However, if the results are not roughly the same, then add more documents at random until the process stabilizes, i.e., results are roughly the same. Alternatively, one can perform some other measure of statistical completeness/change in adding a few more documents, or any other method for statistical completeness or significance.

In accordance with an exemplary embodiment of the present invention, for example for music files, the present invention characterizes the music files with “extra features” to compute music affinity (or generally, music “meaning”) or obtain a “rich enough” statistical sample (i.e., in the corpora (5) and (9)). The corpus (13) of music files necessary to perform information retrieval needs to be a full set of all available documents (i.e., music files), but the present invention, at least in certain embodiments, does not need to characterize these music files with “extra features” as with the corpora (5) and (9).

In another aspect, the present systems and methods described relate herein are applicable to diffusion geometry and document analysis, processing and information extraction. These methods and systems described herein are applicable at least in the case in which, as is typical, the given data to be analyzed can be thought of as a collection of data objects, and for which there is some at least rudimentary notion of what it means for two data objects to be similar, close to each other, or nearby.

In an embodiment, the present invention relates to the fact that certain notions of similarity or nearness of data objects (including but not limited to conventional Euclidean metrics or similarity measures such as correlation, and many others described below) are not a priori very useful inference tools for sorting high dimensional data. In one aspect of the present invention, we provide techniques for remapping digital documents, so that the ordinary Euclidean metric becomes more useful for these purposes. Hence, data mining and information extraction from digital documents can be considerably enhanced by using the techniques described herein. The techniques relate to augmenting given similarity or nearness concepts or measures with empirically derived diffusion geometries, as further defined and described herein.

An aspect of the present invention relates to the fact that, without the present invention, it is not practical to compute or use diffusion distances on high dimensional data. This is because standard computations of the diffusion metric require d*n² or even d*n³ number of computations, where d is the dimension of the data, and n the number of data points. This would be expected because there are O(n²) pairs of points, so one might believe that it is necessary to perform at least n² operations to compute all pairwise distances. However, the present invention, as disclosed, includes a method for computing a dataset, often in linear time O(n) or O(nlog(n)), from which approximations to these distances, to within any desired precision, can be computed in fixed time.

The present invention provides a natural data driven self-induced multiscale organization of data in which different time/scale parameters correspond to different representations of the data structure at different levels of granularity, while preserving microscopic similarity relations.

Examples of digital documents in this broad sense, could be, but are not limited to, an almost unlimited variety of possibilities such as sets of object-oriented data objects on a computer, sets of web pages on the world wide web, sets of document files on a computer, sets of vectors in a vector space, sets of points in a metric space, sets of digital or analog signals or functions, sets of financial histories of various kinds (e.g. stock prices over time), sets of readouts from a scientific instrument, sets of images, sets of videos, sets of audio clips or streams, one or more graphs (i.e. collections of nodes and links), consumer data, relational databases, to name just a few.

In each of these cases, there are various useful concepts of said similarity, closeness, and nearness. These include, but are not limited to, examples given in the present disclosure, and many others known to those skilled in the art, including but not limited to cases in which the content of the data objects is similar in some way (e.g. for vectors, being close with respect to the norm distance) and/or if data objects are stored in a proximal way in a computer memory, or disk, etc, and/or if typical user-interaction with the objects is similar in some way (e.g. tends to occur at similar time, or with similar frequency), and/or if, during an interactive process, a user or operator of the present invention indicates that the objects in question are similar, or assigns a quantitative measure of similarity, etc. In the case of nodes in a graph, or in the case of two web pages on the Internet, the objects can be thought of as similar for reasons including, but not limited to, cases in which there is a link from one to the other.

Note that, in practical terms, although mathematical objects, such as vectors or functions, are discussed herein, the present invention relates to real-world representations of these mathematical objects. For example, a vector could be represented, but is not limited to being represented, as an ordered n-tuple of floating point numbers, stored in a computer. A function could be represented, but is not limited to be represented, as a sequence of samples of the function, or coefficients of the function in some given basis, or as symbolic expressions given by algebraic, trigonometric, transcendental and other standard or well defined function expressions.

In the present invention it is convenient to think of a digital document as an ordered list of numbers (coordinates) representing parametric attributes of the document. Note that this representation is used as an illustrative and not a limiting concept, and one skilled in the art will readily understand how the examples described above, and many others, can be brought in to such a form, or treated in other forms of representation, by techniques that are substantially equivalent to those describe herein.

Such digital documents, e.g. images and text documents having many attributes, typically have dimensions exceeding 100. In accordance with an embodiment of the present invention, the use of given metrics (i.e., notions of similarity, etc.) in digital document analysis is restricted only to the case of very strong similarity between documents, a similarity for which inference is self evident and robust. Such similarity relations are then extended to documents that are not directly and obviously related by analyzing all possible chains of links or similarities connecting them. This is achieved through the use of diffusions processes (processes that are analogous to heat-flow in a mathematical sense that will be described herein), and this leads to a very simple and robust quantity that can be measured as an ordinary Euclidean distance in a low dimensional embedding of the data. The term embedding as used herein refers to a “diffusion map” and the distance thereby defined as a “diffusion metric.”

In yet another aspect, the present invention relates in part to influencing the position or presence on a search result list generated by a computer network search engine and for influencing a position or presence or placement within an advertising section of document or rendering of a document or meta-document on a computer network. In part, systems and methods are disclosed for enabling information providers using a computer network such as the Internet to influence a position for a search listing within a search result list generated by a computer network search engine and for influencing a position or presence or placement of a listing within a document or rendering of a document or meta-document on a computer network. The term listing as used herein refers to any digital document content that a provider wishes to have listed, rendered, displayed, or otherwise delivered using a computer network, by one practicing the present invention. Such a listing can be, but is not limited to banner advertisements, text advertisements, video clips and other media, and can be as simple as a link to another web page or web site. The term advertising opportunity herein refers to any instance where there is an opportunity to position a search listing, or position, place or present a listing within an advertising or other section within a document or rendering of a document or meta-document on a computer network. The term advertising as used herein refers to any act of listing, rendering, displaying, or otherwise delivering a listing or other content using a computer network, in exchange for compensation or other value.

More generally, in this aspect, the present invention relates to the strategic matching of online content for optimization of collaborative opportunities for one web page or web site to display content related to another web page or web site. Examples of such use include, but are not limited to:
1. the addition of links to a web site, designed to increase intra-site click through rate;
2. the addition of links between a strategic set of web sites, designed to increase inter-site click through rates; and
3. the provision of services designed to pair up product and service listings with advertising opportunities

In accordance with an embodiment of the present invention, the system and method provides a database having accounts for the listing providers. Each account contains contact and billing information for a listing provider. In addition, each account contains at least one search listing having at least two components: 1. at least one digital document describing the product, service or other listing to be positioned, placed, or presented; and 2. a bid amount, which is preferably a money amount, for a listing. The listing provider may add, delete, or modify a search listing after logging into his or her account via an authentication process. The present invention includes methods for determining the eligibility of any listing for any given advertising opportunity. During an advertising opportunity, the selection of, or positioning of a listing is influenced by a continuous online competitive bidding process. The bidding process occurs whenever an advertising opportunity arises. The system and method of the present invention then compares all bid amounts for those listings eligible for the advertising opportunity in question, and generates a rank value for all eligible listings. The rank value generated by the bidding process determines where the network information providers listing will appear in the context determined by the advertising opportunity. A higher bid by a network information provider will result in a higher rank value and a more advantageous placement.

There are current systems that, for example, display advertisements within a paid section of a web page, wherein the choice of advertisements displayed relates to keyword matching and other similar techniques, and the preferential positioning of the advertisements displayed is determined by a bidding process. For example, Google, Inc. practices this technique (see “Google AdSense” at: <http://www.google.com/ads/>).

There are current systems that, for example, display advertisements within a section of a search engine query result page, wherein the choice of advertisements displayed relates to keyword matching and other similar techniques, and the preferential positioning of the advertisements displayed is determined by a bidding process. For example, Google, Inc. practices this technique (see “Google AdWords” at: <http://www.google.com/ads/>).

In these current systems, advertisements are placed by a method that uses keywords, but keywords can be ambiguous. For example, the keyword “nails” might bring up advertisements for hardware stores in these prior art systems, even when searched from a website about women's beauty, where results about nail polish, etc, are more appropriate as top advertisements. Hence there is a need for methods and systems as disclosed herein, which, in part, are able to resolve such ambiguities.

The diffusion geometric techniques and other techniques disclosed herein provide a new and novel means of displaying advertisements that are related to content and for which preferential positioning of the advertisements displayed can be determined by relevance to the context, as well as influenced by a bidding process or other economic considerations. Algorithms for preferential positioning of advertisements, etc, are disclosed herein.

An aspect of the present invention relates to the application of the above algorithm and related ones, to the problem of automatically designing or augmenting the links within a single company's web site. Web companies often wish to increase the amount of traffic on their web sites, and the amount of time and volume of data viewed by customers of their sites. Offering links from pages on the site to related pages on the site provides a proactive replacement for an outside search engine. Users will be able to find what they need (e.g. if they enter a site from the result of a search engine), and then find related information, and thus be motivated to “explore” the site. This is true for sites in general, and also specifically when the site in question is one that contains catalog-like or other listings of products and services. In a store, customers often begin shopping by looking at one product but end up buying another product. By having tight links between related products, online sites can achieve this same “emotional buying” phenomenon.

An aspect of the present invention relates to the application of the above algorithm and related ones, to the problem of automatically designing or augmenting the links between two or more companies' web sites. Web companies often wish to increase the amount of traffic that they receive from or provide to affiliated sites. The present invention provides a method to design or augment the links between these sites, thereby linking related content, and organically increasing this traffic. One skilled in the art will see how to do this, and how it results in economic benefit to the parties in question, each in a way analogous to the case described in the previous paragraph.

In accordance with an embodiment of the present invention, a method and system retrieves information in response to an information retrieval request comprises extracting additional information from a first corpus of data elements based on the request. The request is modified based on the additional information to refine the scope of information to be retrieved from a second corpus of data elements. The information is retrieved from the second corpus of data elements based on the modified request.

In accordance with an embodiment of the present invention, a method of influencing traffic between predetermined web pages comprises the steps of: determining diffusion geometry coordinates of a set of web pages, the set of web pages comprising at least one of the predetermined web pages; and determining links between the web pages based on the diffusion geometry coordinates.

In accordance with an embodiment of the present invention, a computer readable medium comprises code for retrieving information in response to an information retrieval request, the code comprising instructions for: extracting additional information from a first corpus of data elements based on the request; modifying the request based on the additional information to refine the scope of information to be retrieved from a second corpus of data elements; and retrieving information from the second corpus of data elements based on the modified request.

In accordance with an embodiment of the present invention, a computer readable medium comprises code for influencing traffic between predetermined web pages, the code comprising instructions for: determining diffusion geometry coordinates of a set of web pages, the set of web pages comprising at least one of the predetermined web pages; and determining links between the web pages based on the diffusion geometry coordinates.

In accordance with an embodiment of the present invention, a system for retrieving information in response to an information retrieval request comprises: an extracting module for extracting additional information from a first corpus of data elements based on the request; a processing module for modifying the request based on the additional information to refine the scope of information to be retrieved from a second corpus of data elements; and a retrieving module for retrieving information from the second corpus of data elements based on the modified request.

In accordance with an embodiment of the present invention, a system for influencing traffic between predetermined web pages comprises a processing module for determining diffusion geometry coordinates of a set of web pages, the set of web pages comprising at least one of the predetermined web pages; and determining links between the web pages based

In accordance with an exemplary embodiment of the present invention, a method for inferring/estimating missing values in a data matrix d(q, r) having a plurality of rows and columns comprises the steps of: organizing the columns of the data matrix d(q, r) into affinity folders of columns with similar data profile, organizing the rows of the data matrix d(q, r) into affinity folders of rows with similar data profile, forming a graph Q of augmented rows and a graph R of augmented columns by similarity or correlation of common entries; and expanding the data matrix d(q, r) in terms of an orthogonal basis of a graph Q×R to infer/estimate the missing values in said data matrix d(q, r) on the diffusion geometry coordinates.

In accordance with an exemplary embodiment of the present invention, the data matrix d(q, r) comprises questionnaire data and the inventive method for inferring/estimating missing values in a data matrix d(q, r) additionally comprises the step of filling in an unknown response to a questionnaire to infer/estimate missing values in the data matrix d(q, r).

In accordance with an exemplary embodiment of the present invention, the inventive method for inferring/estimating missing values in a data matrix d(q, r) additionally comprises the step of expanding the data matrix d(q, r) in terms of a tensor product of wavelet bases for graphs Q and R.

In accordance with an exemplary embodiment of the present invention, the inventive method for inferring/estimating missing values in a data matrix d(q, r) additionally comprises the steps of, for each tensor wavelet in basis, computing a wavelet coefficient by averaging on the support of the tensor wavelet and retaining the coefficient in the expansion only if validated by a randomized average.

In accordance with an exemplary embodiment of the present invention, the inventive method for inferring/estimating missing values in a data matrix d(q, r) additionally comprises the steps of constructing diffusion wavelets and taking supports of the resulting diffusion wavelets at a fixed scale on said columns of said graph R, for at least one of the organizing step.

In accordance with an exemplary embodiment of the present invention, the data matrix d(q, r) comprises initial customer preference data and the inventive method for inferring/estimating missing values in a data matrix d(q, r) further comprises the step of predicting additional customer preferences from the data matrix d(q, r).

In accordance with an exemplary embodiment of the present invention, the data matrix d(q, r) comprises measured values of an empirical function f(q, r) and the invention method for inferring/estimating missing values in a data matrix d(q, r) further comprises the step of nonlinear regression modeling of the empirical function f(q, r).

In accordance with an exemplary embodiment of the present invention, the data matrix d(q, r) is a questionnaire d(q, r) and the inventive method further comprises the steps of determining whether a response (q₀, r₀) to the questionnaire d(q, r) is an anomalous response.

In accordance with an exemplary embodiment of the present invention, the inventive method further comprises the steps of generating a dataset d1(q, r) comprising responses to the questionnaire d(q, r), omitting the response (q₀, r₀) from the dataset d1(q, r), reconstructing the missing response (q₀, r₀) from the dataset d1(q, r) to provide a reconstructed value, comparing the reconstructed value to the response (q₀, r₀), and determining the response (q₀, r₀) to be anomalous when a distance between the reconstructed value and the response (q₀, r₀) is larger than a pre-determined threshold.

In accordance with an exemplary embodiment of the present invention, the data matrix d(q, r) comprises data relevant to fraud or deception and the inventive method further comprises the step of detecting fraud or deception from said data matrix d(q, r).

In accordance with an exemplary embodiment of the present invention, a computer readable medium comprises code for inferring/estimating missing values in a data matrix d(q, r) having a plurality of rows and columns. The code comprises instructions for organizing the columns of said data matrix d(q, r) into affinity folders of columns with similar data profile, organizing the rows of said data matrix d(q, r) into affinity folders of rows with similar data profile, forming a graph Q of augmented rows and a graph R of augmented columns by similarity or correlation of common entries; and expanding the data matrix d(q, r) in terms of an orthogonal basis of a graph Q×R to infer/estimate the missing values in the data matrix d(q, r).

Various other objects, advantages and features of the present invention will become readily apparent from the ensuing detailed description, and the novel features will be particularly pointed out in the appended claims.

### BRIEF DESCRIPTION OF THE DRAWINGS

For a more complete understanding of the present invention, reference is now made to the following descriptions taken in conjunction with the accompanying drawing, in which:

FIG. 1 shows a block diagram of a contextualized search engine in accordance with an embodiment of the present invention;

FIG. 2 shows a schematic representation of an imagined forest, with trees and shrubs, presumed to burn at different rates;

FIG. 3 shows an exemplary flow chart for computing multiscale diffusion geometry in accordance with an embodiment of the present invention; and

FIG. 4 illustrates a Public Find Similar Document Internet Utility in accordance with an embodiment of the present invention.

The discussion associated with the figure illustrates an embodiment of the present invention in the context of analysis of the spread of fire in the forest, and illustrates a use of the embodiment in the analysis of diffusion in a network.

### DETAILED DESCRIPTION OF THE EMBODIMENTS

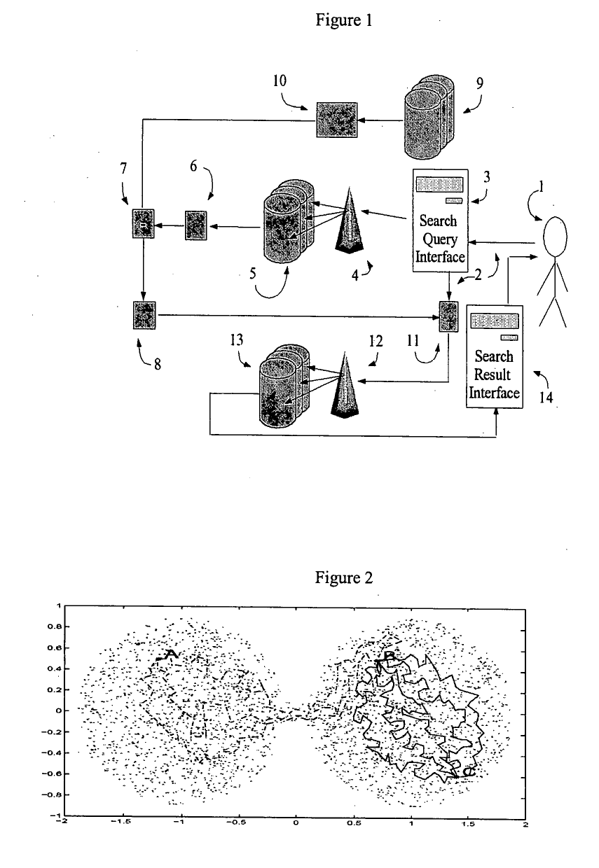

As shown in FIG. 1, there is illustrated a flow chart describing an exemplary method in accordance with an embodiment of the present invention (fr_matr_bin( )):
Step 110: A user (1) enters a first search query (2) into a search query user interface (3).
Step 120: The query (2) is sent to a first search engine (4).
Step 130: The first search engine (4) performs a search on a first one or more corpora of documents (5) using the query (2).
Step 140: Mean word frequencies f0 (6) are computed on the set of documents returned by the first search engine (4).
Step 150: Mean word frequencies f1 (10) are computed for a second one or more corpora of documents (9). (It is appreciated that this step can be done once at initialization.)
Step 160: The difference d (7) f0−f1=is calculated.
Step 170: The set of words (8) is identified corresponding to those top K words for which d (7) is greatest (for some fixed parameter K), or e.g., to those words for which d is greater than some threshold t (for some fixed parameter t).
Step 180: A new search query (11) is defined by combining the first query (2) and the set of words (8). For example if the first query (2) is “nail”, and the set of words (8) is {“polish”, “beauty”, “manicure”}, then the new search query (11) could be “nail AND (polish OR beauty OR manicure)”. Other algorithms for this combination are disclosed herein.
Step 190: The new query is sent to a second search engine (12) disposed to search a third one or more corpora of documents (13).
Step 200: The results returned by the second search engine (12) are displayed on a search result user interface (14).

In certain embodiments, the corpora (9) represent the language as a whole. For example, if the target searches are conducted in English, then corpora (9) can be a random sample of documents in the English language. The corpora (5) are used to define the subject(s) of interest to the user of the search. For example, if the subject of interest is Major League Baseball, then the documents in question can be a web-craw of www.mlb.com, as well as news articles, encyclopedia articles, etc, on the subject of baseball.

In this way, it is seen that the algorithm of the present invention, in certain embodiments, acts to find those words which are much more likely to occur in documents that meet the first search query criteria, within the subject(s) of interest to the user of the search, as compared with the generic occurrence of the words within the target search language as a whole.

Note that in certain embodiments the corpora (9) can be taken to be the same as (5). In such case, it is seen that the algorithm of the present invention acts to find those words which are much more likely to occur in documents that meet the first search query criteria, within the subject(s) of interest to the user of the search, as compared with the generic occurrence of the words within the subject(s) of interest to the user of the search. In other variants of the algorithm, (9) and (10) are omitted, f1=0, and (7) d=f0 (6).

The corpora (13) can be, in certain embodiments, the entire Internet, or the set of documents indexed by a public or private search engine. Since, in certain embodiments, the algorithm of the present invention takes a first search query, and produces a second search query, each suitable for full text search, these queries can be passed to search engines via techniques standard in the art, including but not limited to HTTP requests and/or network interfaces such as SOAP. The results returned by these search engines can be displayed as is standard in the art, including but not limited to display in a browser by rendering results encoded with HTML, XML, Java, JavaScript, Python, Perl, PHP, etc.

In certain embodiments, at least on of the searches described can be performed by matrix techniques. More specifically, suppose that one has a set of N documents, with a vocabulary or reduced vocabulary of M words. One can then form the N X M matrix W, so that W(i,j)=the number of times that word number j occurs in document number i.

In certain embodiments, provisions are made to ignore stop words. Stop words are words that are commonly used, such as “the,” “an,” or “and”, that are often deliberately ignored by search applications when responding to a query. Often stop words are the most common words in the language. In some embodiments, sets of stop words are augmented by adding additional words (e.g. Common words) that are specific to the corpora used.

In certain embodiments, provisions are made to correct spelling errors. This can be done, for example, by using SOUNDEX scores to identify words that are misspelled but are most likely meant to be other given words. One can also employ other techniques, such as a list of commonly misspelled words, phrases and queries. In the present context, statistics and other information, including but not limited to information from the corpora and/or the search logs, can be used to identify misspellings and likely suggested replacements for input queries. Spelling errors in the corpora can also be flagged and automatically, semi-automatically, partially-assisted or manually corrected.

In accordance with embodiments of the present invention, certain word frequency coefficients, or differences between word frequencies, are set to zero when they are below a given threshold. In this way, “noise” is removed from the process. For example, in the case where documents are being tested for the presence of a set of words or phrases as in the search in step 130 of FIG. 1, one can take only those documents that contain the phrase more than a certain number of times. This number can be fixed, or it can be some fraction of the average number, where the average is taken, for example, over the set of documents for which the value is at least 1. A corresponding type of threshold can also be applied in one or more of steps, for example to steps 170, 180 or 190.

In certain embodiments, searches are implemented in part using sparse matrix representations. For example, given the matrix W(i,j) as described herein, for a first one or more corpora, and an initial search query based on the presence of all of the words w_1, w_2, . . . , w_n, and the absence of all of the words x_1, . . . , x_m, one can perform the search in step 130 by finding those rows of W that have non-zero values in all of the columns corresponding to the indices of the words w_1, . . . , w_n, and have only zero values in all of the columns corresponding to the words x_1, . . . , x_m. Note that the property of containing all of a set of words corresponds to the Boolean AND. For the Boolean OR, one can take the set of rows of W that have non-zero values in at least one of the columns corresponding to the indices of the words w_1, . . . , w_n, etc. Steps 140 and 150 correspond to summing a matrix over all columns. In the case of step 140, the sum is over the sub matrix of rows selected as described in this paragraph. In the case of step 150, it is, for example, a sum over a whole matrix.

Note that, since most words often appear in only a few documents, the matrix W is sparse, and sparse matrix math is used in certain embodiments, to carry out the steps described. A typical sparse matrix representation can be to store ordered triples, {i_k, j_k, v_k}, for k=1 . . . K, meaning that W(i_k, j_k)=v_k, and W(i,j)=0 for all i,j pairs that occur in no listed triple. Note that this sparse form, in some embodiments, is stored sorted by i and then j. It is also convenient, in some embodiments, to store a second version, sorted by j and then by i. The former is useful at least when one want to find the words J_i that occur in a given document i. The latter is useful at least when one wants to find the documents I_j that contain a particular word j. Both of these kinds of finding are used in certain embodiments as described herein.

In accordance with exemplary embodiments of the present invention, step 180 defines the new query (11) by taking the logical conjunction of the original query (2) with the logical disjunction of the set of new search terms (8). That is, if the original query (2) were represented by x, and the new search term (8) by the set {a, b, c, . . . , z} (with no assumption about the size of the set), then the new query (11) would, in the one exemplary embodiment, be (x AND a OR b OR c OR . . . OR z). Note that in this description, x itself may be a compound or complex query. For example, it can be, using the notation of the Google search engine, “nails-hardware” (which means “find those documents that contain the word “nails” and do not contain the word “hardware”).

In certain embodiments, a more varied set of output logical structures can be used. In such embodiments, the elements (6) and (8) in FIG. 1 can be replaced by elements (6′) and (8′) respectively as follows: (6′) is collectively the word frequencies of, and a word-document matrix or similar structure that allows one to compute at least the frequency of occurrence of each word in each document. Similarly, the element (8′) is collectively both the set of words corresponding to those top K words for which d (7) is greatest, together with the word-document sub-matrix (e.g. an L×K matrix, m1(i,j)) (collectively element 8′).

In accordance with certain embodiments, the new query (11) has the form of a logical conjunction of a set of logical parts. The first part is the original query x and the whole of (11) has the form (x AND A_1 OR A_2 OR . . . OR A_K). In certain of these embodiments, each of the A_i is a conjunction of those words corresponding to columns of m1 which are well correlated to column i. That is, A_1 is the set of words that are highly correlated to the word corresponding to column 1 of m1, all “AND'ed” together. A_2 for the word corresponding to column 2, etc. In this way, words that are highly correlated with each other, when used in documents that satisfy the original search query, are required to appear together to satisfy the advanced rewritten query. In certain embodiments, the absolute requirement of appearing together is relaxed to a statistical favoring of those documents for which at least some of the words appear together.

Note that contextualized search engines can be generated for almost any topic given the methods and systems of the present invention described herein. In particular, there are public web directories, such as DMOZ (see www.dmoz.org), that give pointers to web pages and web sites, arranged by topics and sub-topics. In certain embodiments of the present invention, one or more corpora of documents are obtained, at least in part, automatically or semi-automatically, by web crawling from a topic or sub topic within DMOZ, or the Google directory, or Yahoo directory, or some other directory of documents.

Certain embodiments of the present invention can be used, for example, to discover similarity or affinity between songs, and/or between artists, in the domain of music affinity. In such embodiments, the corpora can consist, at least in part, of set of playlists (lists of song titles). In this case, individual songs take the place of individual words. The playlists take the place of documents discussed herein. Then, given a query that has the form: “here are a few songs: s1, s2, . . . , sn; find songs that are related”, an embodiment would select those certain playlists that contain one or many of the songs s_, and then find those songs that are more likely to occur in certain playlists, as compared with their occurrence in a generic playlist. In accordance with an aspect of the present invention, one can interchange the actual song with the artist or performer that has composed, recorder or performed the song in question. In this way, the embodiment determines “artist affinity”.

In accordance with an embodiment of the present invention, a method and system for automatically discovering one or more genres associated with a target (e.g. the target could be a particular music artist, or set of artists, or a genre, or set of genres), is as follows. Create one or more corpora of documents from music reviews, music enthusiasts' web pages, music liner notes, and the like. Use the one or more corpora as the element (5) in FIG. 1. Perform the first search, etc. From the resulting set of words (8), extract a subset corresponding to words that are the names of genres. Replace steps 170-190 by a step that filters away all words other than genre terms, and replace step 200 with a step that returns the remaining genre terms as the result to the user. These results, together with their numerical scores from the algorithm, give a weighted genre description associated with the target. For example, one can automatically find the genre(s) associated with any music artist in this way.

Note that one or more additional lists of words and phrases will need to be kept and used to define and recognize the predefined genres. Of course, the searches performed in the algorithms can keep track of parts of speech, capitalization, etc, so that one can distinguish, e.g., between subjects and objects of sentences, and differentiate between, e.g., an artist name that happens to be a homonym for another word. Also, in order to assist in this parsing, one can keep a database of artists, songs, etc.

In the genre example, the columns of the matrix in the algorithm can be restricted to only genre words. Additionally, one can use full-text searching techniques so that multi-word genres are recognized. As a short cut in this embodiment, since there is a small finite list of genres and sub-genres, one could convert each genre “phrase” into a token using techniques standard in the art.

In this and related embodiments, genre can be replaced with any other concept, i.e. band name, country of origin, artist, mood, etc, or any combination. One of skill in the art will readily see that this algorithm applies quite generally as a means for creating an automatic ontological classifier and ontological affinity engine, and applies to all subjects, not just music.

While the above techniques have been described largely in terms of word frequencies and matrix mathematics, one skilled in the art will see that a variety of techniques are available for carrying out the calculations and modeling needed to implement the present invention. Such techniques include, but are not limited to, standard full-text database indexing and information retrieval, as well as diffusion geometry techniques disclosed herein.

In accordance with an embodiment, the present invention relates to multiscale mathematics and harmonic analysis. There is a vast literature on such mathematics, and the reader is referred to the attached paper by Coifman and Maggioni, in the provisional patent application No. 60/582,242 and the references cited therein. The phrase “structural multiscale geometric harmonic analysis” as used herein refers to multiscale harmonic analysis on sets of digital documents in which empirical methods are used to create or enhance knowledge and information about metric and geometric structures on the given sets of digital documents. The present invention also relates to the mathematics of linear algebra, and Markov processes, as known to one skilled in the art.

The techniques disclosed herein provide a framework for structural multiscale geometric harmonic analysis on digital documents (viewed, for illustration and not limiting purposes, as points in R″ or as nodes of a graph). Diffusion maps are used to generate multiscale geometries in order to organize and represent complex structures. Appropriately selected eigenfunctions of Markov matrices (describing local transitions inferences, or affinities in the system) lead to macroscopic organization of the data at different scales. In particular, the top of such eigenfunctions are the coordinates of the diffusion map embedding.

The mathematical details necessary for the implementation of the diffusion map and distance are detailed in the U.S. provisional patent application No. 60/582,242. Particularly, the articles disclosed in the provisional patent application No. 60/582,242: “Geometric Diffusions as a Tool for Harmonic Analysis and Structure Definition of Data” by Coifman, et al. (hereinafter referred to as “Coifman et al.” reference), and Coifman & Maggioni reference, which are incorporated by reference in their entirety. The discussion in these papers, Coifman & Maggioni and Coifman et al., describe the construction of the diffusion map in a quite general manner. A diffusion map is constructed given any measure space of points X and any appropriate kernel k(x,y) describing a relationship between points x and y lying in X. Starting with such a basic point of view, the article provides anyone skilled in the art the means and methods to calculate the diffusion map, diffusion distance, etc.

These means and methods include, but are not limited to the following: 1) construction and computation of diffusion coordinates on a data set, and 2) construction and computation of multiscale diffusion geometry (including scaling functions and wavelets) on a data set.

The construction and computation of diffusion coordinates on a data set is achieved as described herein. These Coifman & Maggioni and Coifman et al. papers referenced herein provide additional details. Below are descriptions of algorithms as used in certain embodiments of the present invention.

Algorithm for Computing Diffusion Coordinates

This algorithm acts on a set X of data, with n points—the values of X are the initial coordinates on the digital documents. The output of the algorithm is used to compute diffusion geometry coordinates on X.

Inputs:
An n×n matrix T: the value T(x,y) measures the similarity between data elements x and y in X
An optional threshold parameter ε with a default of ε=0: used to “denoise” T by, e.g., setting to 0 those values of T that are less than ε.
An optional output dimension k, with a default of k=n: the desired dimension of the output dataspace.

Outputs:
An n×k matrix A: the value A(n₀, −) gives the coordinates of the n₀^{th} point, embedded into k-dimensional space, at time t=1.
A sequence of eigenvalues λ₁, . . . , λₖ

Algorithm:
SetT₁(x,y)=T(x,y) if |T(x,y)|>ε, T₁(x,y)=0 otherwise
Set λ₁, . . . , λₖ equal to the largest k eigenvalues of T₁
Set A to the matrix, the columns of which are the eigenvectors of T₁ corresponding to the largest k eigenvalues of T₁.

Then, using the above, the diffusion coordinates at time t, diffCoordₜ(x) is computed via:
DiffCoord_{t.}(x)={λᵢ^{t}A(x,i)}_{i=1, . . . , k}

and the diffusion distance at time t, dₜ(x, y) is computed via the Euclidean distance on the diffusion coordinates:

$${{d}_{t} ( x , y )}^{2} = {\sum }_{i = 1}^{k} {{λ}_{i}^{2 t} ( A ( x , i ) - A ( y , i ) )}^{2}$$

Note that the thresholding step can be more sophisticated. For example, one could perform a smooth operation that sets to 0 those values less than ε₁ and preserves those values greater than ε₂, for some pair of input parameters ε₁<ε₂. Multi-parameter smoothing and thresholding are also of use. Also note that the matrix T can come from a variety of sources. One is for T to be derived from a kernel K(x,y) as described in the Coifman & Maggioni and Coifman et al. papers referenced herein. K(x,y) (and T) can be derived from a metric d(x,y), also as described in the Coifman & Maggioni and Coifman et al. papers referenced herein. In particular, T can denote the connectivity matrix of a finite graph. These are but a few examples, and one of skill in the art will see that there are many others. We list several embodiments herein and describe the choice of K or T. For convenience we will always refer to this as K.

The construction and computation of multiscale diffusion geometry (including scaling functions and wavelets) on a data set is achieved as described herein. The Coifman & Maggioni and Coifman et al. papers referenced herein provide additional details. Below are descriptions of algorithms as used in certain embodiments of the present invention.

Algorithm for Computing Multiscale Diffusion Geometry

This algorithm acts on a set X of data, with n points—the values of X are the initial coordinates on the digital documents. The output of the algorithm is used to compute multiscale diffusion geometry coordinates on X, and to expand functions and operators on X, etc., as described in the papers.

Inputs:
An n×n matrix T: The value T(x,y) measures the similarity between data elements x and y in X
A desired numerical precision ε₁
An optional threshold parameter ε with a default of ε=0: Used to “denoise” T by, e.g., setting to 0 those values of T that are less than ε. Optional stopping time parameters K, Iₘₐₓ, with a default of K=1, and Iₘₐₓ=infinity: Parameters that tell the algorithm when to stop.

Outputs:
A sequence of point sets Xᵢ, a sequence of sets of vectors Pᵢ with each element of Pᵢ indexed by elements of Xᵢ, and a sequence of matrices Tᵢ which is an approximation of the restriction of T²^{^{t}} to Xᵢ

Algorithm:
Set T₀(x,y)=T(x,y) if |T(x,y)|>ε, T₁(x,y)=0 otherwise
Set X₀=X; P₀={δₓ}_{xεX}
Set i=1 and loop:
   Set \tilde{P}ᵢ={Tᵢ₋₁x}_{xεP}_{_{i−1}}
   Set Pᵢ=LocalGS_{ε}_{₁}(\tilde{P}ᵢ)
   Set Xᵢ=<the index set of Pᵢ>
   Set Tᵢ=Tᵢ₋₁*Tᵢ₋₁ restricted to Pᵢ, and written as a matrix on Pᵢ.
   Set i=i+1
   Repeat loop until either Pᵢ has K or fewer elements, or i=Iₘₐₓ

Above, LocalGS_{ε}( ) is the local Gram-Schmidt algorithm described in the Coifman & Maggioni and Coifman et al. papers referenced herein (an embodiment of which is describe below), but in various embodiments it can be replaced by other algorithms as described in the Coifman & Maggioni and Coifman et al. papers referenced herein. In particular, a modified Gram Schmidt can be used. See the Coifman & Maggioni and Coifman et al. papers referenced herein for details. Note as before that the thresholding step can be more sophisticated, and the matrix T can come from a variety of sources. See the discussion relating to preceding algorithm described herein. A person skilled in the art will readily understand several variations and generalizations of the algorithm above, including those that are suggested and presented in the Coifman & Maggioni and Coifman et al. papers referenced herein.

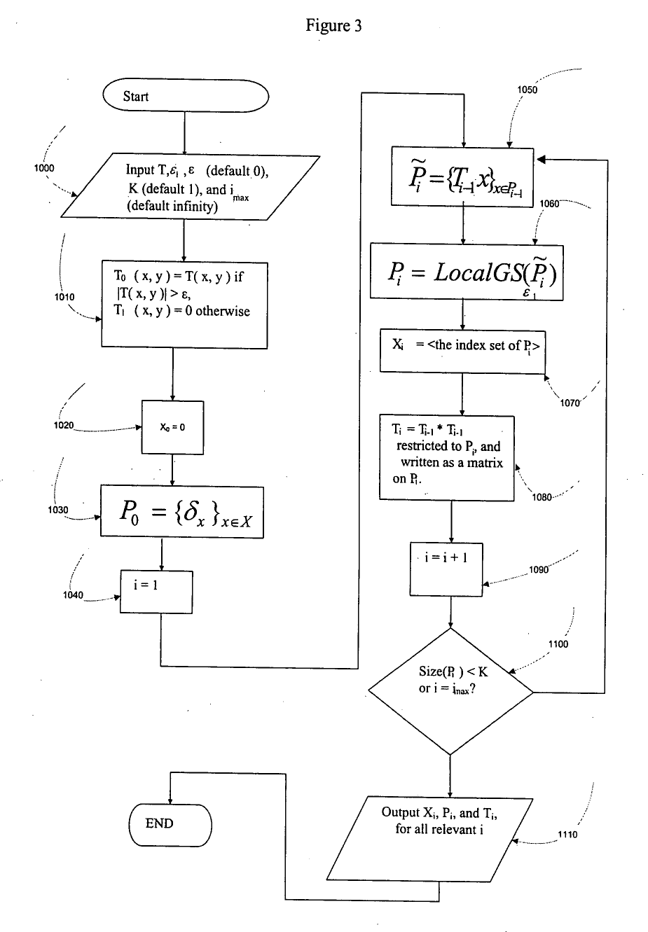

FIG. 3 depicts the above algorithm for computing mutiscale diffusion geometry as a flowchart in accordance with an embodiment of the present invention. In step 1000, the system reads the inputs into the algorithm. Various variables utilized in the algorithm are initialized in steps 1010, 1020, 1030, and 1040. The system a loop and sets \tilde{P}ᵢ={Tᵢ₋₁x}_{xεP}_{_{i−t}} in step 1050. The system computes the local Gram Schmidt orthonormaliation in step 1060. The system sets Xᵢ to be the index set of Pᵢ in step 1070. The system computes the next power of the matrix T, restricted to and written as a matrix on the appropriate set in step 1080. The system increments the loop index i in step 1090. In step 1100, the system performs a loop-control test: if the stopping conditions are met, we get out of the loop, otherwise the system return to step 1050. The system outputs the results of the algorithm in step 1110.

The following gives pseudo-code for a construction of the diffusion wavelet tree in accordance with an embodiment of the present invention, using the notation of the provisional application No. 60/582,242.

{Φⱼ}ⱼ₌₀^{J},{Ψⱼ}ⱼ₌₀^{J-1},{[T²^{ⱼ}]Φⱼ^{Φ}ⱼ}ⱼ₌₁^{J} [symbol] DiffusionWaveletTree ([T]Φ₀^{Φ}₀,Φ₀,J,SpQR,τ) // Input:
// [T]Φ₀^{Φ}₀ : a diffusion operator, written on the o.n. basis Φ₀
// Φ₀ : an orthonormal basis which τ-spans V ₀
// J : number of levels to compute
// SpQR : a function compute a sparse QR decomposition, template below.
// τ: precision
// Output:
// The orthonormal bases of scaling functions, Φⱼ, wavelets, Ψⱼ, and
// compressed representation of T²^{ⱼ} on Φⱼ, for j in the requested range.
for j = 0 to J − 1 do

1. [Φⱼ₊₁]Φⱼ , [T]Φ₀^{Φ}₁ [symbol] SpQR([T²^{ⱼ}]Φⱼ^{Φ}ⱼ, [symbol] )
2. Tⱼ₊₁ := [T²^{ⱼ₊₁}]Φⱼ₊₁^{Φ}ⱼ₊₁ [symbol] [Φⱼ₊₁]_{Φ}^{ⱼ}[T²^{ⱼ}]_{Φj}^{Φ}ⱼ[Φⱼ₊₁]_{Φ}^{ⱼ}*
3. [Ψⱼ]_{Φ}^{ⱼ} [symbol] SpQR(/_{<Φ}^{ⱼ}_{>}− [Φⱼ₊₁]Φⱼ[_{Φ}^{ⱼ₊₁}]_{Φ}^{ⱼ}*,τ)

end
Function template:
Q,R [symbol] SpQR (A,ε) // Input:
// A: sparse n × n matrix
// ε: precision
// Output:
// Q,R matrices, possibly sparse, such that A = _{τ}QR,
// Q is n × m and orthogonal,
// R is m × n, and upper triangular up to a permutation,
// the columns of Q τ-span the space spanned by the columns of A.

An example of the SpQR algorithm is given by the following:

MultiscaleDyadicOrthogonalization ( [symbol] ,Q,J,ε): // [symbol] : a family of functions to be orthonormalized, as in Proposition 21

// Q : a family of dyadic cube on X
// J : finest dyadic scale
// ε: precision
Φ₀ [symbol] Gram-Schmidt_{≡}(∪k∈K,j ^{Ψ}|_{Q}_{_{J,k}}) / [symbol] 1 do

1. for all k ∈Kⱼ₊₁,

a. Ψ̅_{l,k} [symbol] Ψ|_{QJ+1,k} \ [symbol] _{QJ+i-1,k}·⊂_{QJ+l,k}Ψ|_{QJ+l-1,k′}
b. \tilde{Φ}_{l,k} [symbol] Gram-Schmidt_{≡}(\tilde{Ψ}_{l,k})
c. Φ_{l,k} [symbol] Gram-Schmidt₌(\tilde{Φ}_{l,k})

2. end
3. / [symbol] / + 1

until Φⱼ is empty.

A person skilled in the art will readily understand several variations and generalizations of the algorithm above, including those that are suggested and presented in the cited papers.

In some embodiments of the present invention, the following version of the local Gram Schmidt procedure is used:

Algorithm for Computing LocalGS_{ε}(P)

This algorithm acts on a set \tilde{P} of vectors (functions on X).

Inputs:
A set of vectors \tilde{P}, defined on X
A desired numerical precision ε₁

Outputs:
A set of vectors P

Algorithm:
Set j=0
Set P=the empty list
Set Ψ₀=\tilde{P}
LOOP0:
Pick dⱼ such that the vectors in Ψⱼ are each supported in a ball of size dⱼ or less
Pick a point in X, at random. Call it x(j,0).
Let i=1
Loop1:
   Pick x(j,i) to be a closest point in X which is at distance at least 2dⱼ from each of the points x(j,0), . . . , x(j,i−1)
   If there is no such point x(j,i), set Kⱼ=(i−1), and break out of the loop1, otherwise, set i=i_{—}+1, and goto loop1:
Set Ξⱼ=the set of vectors in Ψⱼ orthogonalized to P, by ordinary Gram Schmidt (if P is empty, simply set [symbol] ⱼ=Ψⱼ)
Set \tilde{P}ⱼ₊₁ to be the set of vectors, v, in Ψⱼ for which there is some k, with 0<=k<=Kⱼ, such that v is supported in a ball of radius 2dⱼ centered at x(j,k)
Use modifiedGramSchmidt_{68 1} to orthogonalize \tilde{P}ⱼ₊₁ to P; call the result

$${{P}^{\tilde{\sim}}}_{j + 1}$$
(Comment: This orthonormalization is local: each function, being supported on a ball of size dⱼ around some point x, interacts only with the functions in P in a ball of radius 2dⱼ containing x. Moreover, the points in

$${{P}^{\tilde{\sim}}}_{j + 1}$$

therefore have the property that each is supported in a ball of radius 3dⱼ)
Set

$${Φ}_{j + 1} = {modifiedGramSchmidt}_{{ɛ}_{1}} ( {{P}^{\tilde{\sim}}}_{j + 1} ) .$$
(Comment: Observe that this orthonormalization procedure is local, in the sense that each function in

$${{P}^{\tilde{\sim}}}_{j + 1}$$

only interacts with the other functions in

$${{P}^{\tilde{\sim}}}_{j + 1}$$

are supported in the same ball of radius Cdⱼ.)
Set Ψⱼ₊₂=Ψⱼ₊₁−\tilde{P}ⱼ₊₁
Set P←P∪Φⱼ₊₁
If Ψⱼ₊₂ is not empty, set j=j+1 and goto LOOP0
End

As seen from the pseudo-code described herein, the construction of the wavelets at each scale includes an orthogonalization step to find an orthonormal basis of functions for the orthogonal complement of the scaling function space at the scale into the scaling function space at the previous scale.

The construction of the scaling functions and wavelets allows the analysis of functions on the original graph or manifold in a multiscale fashion, generalizing the classical Euclidean, low-dimensional wavelet transform and related algorithms. In particular the wavelet transform generalizes to a diffusion wavelet transform, allowing one to encode efficiently functions on the graph in terms of their diffusion wavelet and scaling function coefficients. In certain embodiments of the present invention, the wavelet algorithms known to those skilled in the art are practiced with diffusion wavelets as described herein.

For example, functions on the graph or manifold can be compressed and denoised, for example by generalizing in the obvious way the standard algorithms (e.g. hard or soft wavelet thresholding) for these task based on classical wavelets.

For example if the nodes of the graph represent a body of documents or web pages, user's preferences (for example single-user or multi-user) are a function on the graph that can be efficiently saved by compressing them, or can be denoised.

As another example, if each node has a number of coordinates, each coordinate is a function on the graph that can be compressed and denoised, and a denoised graph, where each node has as coordinates the denoised or compressed coordinates, is obtained. This allows a nonlinear structural multiscale denoising of the whole data set. For example, when applied to a noisy mesh or cloud of points, this results in a denoised mesh or cloud of points.

Similarly, diffusion wavelets and scaling functions can be used for regression and learning tasks, for functions on the graph, this task being essentially equivalent to the tasks of compressing and denoising discussed herein.

As an example, standard regression algorithms known for classical wavelets can be generalized in an obvious way to algorithms working with diffusion wavelets.

In accordance with an embodiment of the present invention, a space or graph can be organized in a multiscale fashion as follows:

Alternate Multiscale Geometry Algorithm

Inputs:
a set X with a kernel K or some other measure of similarity as described herein;
a number r (a radius)
a stopping parameter L

Output: A sequence X₁, . . . , X_{M} of set of points, yielding a multiscale clustering of the set X

Algorithm:
Compute diffusion geometry of the set X
Set X₀=X
Set i=1
Loop:
   Set Xᵢ to be a maximal set of points in X₁₋₁ with mutual distance >=r in the diffusion geometry with parameter t=2ⁱ
   If Xᵢ has more than L points, set i=i+1 and goto Loop:
End.

In accordance with embodiments of the present invention, the method and system relates to searching web pages on Internets and intranets, and indexing such web pages and the web. In accordance with an aspect of the present invention, the points of the space X represents documents on the Web, and the kernel k will be some measure of distance between documents or relevance of one document to another. Such a kernel can make use of many attributes, including but not limited to those known to practitioners in the art of web searching and indexing, such as text within documents, link structures, known statistics, and affinity information to name a few.

One aspect of the present invention can be understood by considering it in contrast with Google's PageRank, as described, for example, in U.S. Pat. No. 6,285,999, which is incorporated herein by reference in its entirety. In some sense PageRank reduces the web to one dimension. It is very good for what it does, but it throws away a lot of information. With the present invention, one can work at least as efficiently as PageRank, but keep the critical higher-dimensional properties of the web. These dimensions embody the multiple contexts and interdependencies that are lost when the web is distilled to a ranking system. Accordingly, the present invention opens the door to a huge number of novel web information extraction techniques.

In accordance with an embodiment, the present invention is ideal for affinity-based searching, indexing and interactive searches. The Algorithms of the present invention goes beyond the traditional interactive search, allowing more interactivity to capture the intent of the user. We can automatically identify so-called social clusters of web pages. The core algorithm is adapted to searching or indexing based on intrinsic and extrinsic information including items such as content keywords, frequencies, link popularity and other link geometry/topology factors, etc., as well as external forces such as the special interests of consumers and providers. There are implications for alternatives to banner ads designed to achieve the same results (getting qualified customers to visit a merchant's site).

The present invention is ideally suited for addressing the problem of re-parameterizing the Internet for special interest groups, with the ability to modulate the filtering of the raw structure of the WWW to take in to account the interests of paid advertisers or a group of users with common definable preferences. By this, we refer to the concept of building a web index of the kind popular in contemporary web portals. Beyond users and paid advertisers, such filtering is also useful to many others, e.g. market analysts, academic researchers, those studying network traffic within a personalized subnet of a larger network, etc.

In an embodiment of the present invention, a computer system periodically maps the multiscale geometric harmonic diffusion metric structure of the Internet, and stores this information as well as possibly other information such as cached version of pages, hash functions and key word indexes in a database (hereinafter the database), analogous to the way in which contemporary search engines pre-compute page ranking and other indexing and hashing information. As described herein, the initial notion of proximity used to elucidate the geometric harmonic structure can be any mathematical combination of factors, including but not limited to content keywords, frequencies, link popularity and other link geometry/topology factors, etc., as well as external forces such as the special interests of consumers and providers. Next, an interface is presented to users for searching the web. Web pages are found by searching the database for the key words, phrases, and other constraints given by the users query. An aspect of the present invention is that, as seen from this disclosure by one skilled in the art, the search can be accelerated by using partial results to rapidly find other hits. This can be accomplished, for example, by an algorithm that searches in a space filling path spiraling out from early search hits to find others, or, similarly, that uses diffusion techniques as discussed herein to expand on early search hits.

Once the search results are gathered, the results can be presented in ways that relate to the geometry of the returned set of web pages. Popularity of any particular site can be used, as is done in common practice, but this can now be augmented by any other function of the geometric harmonic data. In particular, results can be presented in a variety of evident non-linear ways by representing the higher-dimensional graph of results in graphical ways standard in the art of graphic representation of metric spaces and graphs. The latter can be enhanced and augmented by the multiscale nature of the data by applying these graphical methods at multiple scales corresponding to the multiscale structures described herein, with the user controlling the choice of scale. This presentation of results can also include other interactive and interface elements such as sound.

In an embodiment of the present invention, web search results, web indexes, and many other kinds of data, can be presented in a graphical interface wherein collections of digital documents are rendered in graphical ways standard in the art of graphic representation of such documents, and combined with or using graphical ways standard in the art of graphic representation of metric spaces and graphs, and at the same time the user is presented with an interface for navigation of this graph of representations. As an illustration, this would be analogous to database fly-through animation as is common in the art of flight simulators and other interactive rendering systems. When a user moves near, or clicks on a data element in the representation, further interaction could result such as display, sonification or other activation of the associated object or certain of its characteristics.

In a further aspect, a web browser can be provided in accordance with an embodiment of the present invention, with which the user can view web pages and traverse links in these pages, in the usual way that contemporary browsers allow. However, using the present invention, and in particular the navigation aspect described in the previous paragraph, users can be presented with the option of jumping to another web page that is close to the current web page in diffusion distance, whether or not there is an explicit link between the pages. Of course, again, the navigation can be accomplished in a graphical way. Again, web pages near the current web page can be clustered using standard art clustering techniques applied to the database and the diffusion distance. At any given scale in the multiscale view, each cluster or navigation direction can be labeled with the most popular word, words, phrases or other features common among document in that cluster or direction. Of course, in doing this, as is standard in the art, certain common words such as (often) pronouns, definite and indefinite articles could be excluded from this labeling/voting.

In another aspect, the present invention can be used to automatically produce a synopsis of a web page (hereinafter a contextual synopsis). This can be done, for example, as follows. At multiple scales, cluster a scale-appropriate neighborhood of the web page in question. Compute the most popular text phrases among pages within the neighborhood, weighting according to diffusion distance from current location. Of course, throw out generically common words unless they are especially relevant, for example words like ‘his’ and ‘hers’ are generally less relevant, but in the colloquial phrase “his & hers fashions” these become more relevant. The top N results (where N is fixed a priori, or from the numerical rank of the data), give a description of the web page. Of course, this concept of contextual synopsis applies to all kinds of digital documents, and not just web pages. For example, the method of the present invention can be used to generate automatics reviews of new pieces of music.

The contextual synopsis concept described in the previous paragraph allows one to compare a web page textually to its own contextual synopsis. A page can be scored by computing its distance to its own contextual synopsis. The resulting numerical score can be thought of as a measure analogous to the curvature of the Internet at the particular web page (hereinafter contextual curvature). This information could be collected and sold as a valuable marketing analysis of the Internet. Sub-manifolds given by locally external values of contextual curvature determine “contextual edges” on the Internet, in the sense that this is analogous to a numerical Laplacian (difference between a function at a point, and the average in a neighborhood of the point).

In an aspect of the present invention, it is seen that various information on diffusion-geometric properties of the sites and sets of sites on the Internet can be collected as valuable marketing and analysis material. The technique described hereinabove yields automatic clustering of the Internet at multiple scales, and can therefore be used, as described herein, to build web indexes of the kind popular in contemporary web portals. Moreover, one can use this technique as already described to systematically discover holes in the Internet; that is, non-uniformities or more complex algebraic-topological features of the Internet, that represent valuable marketing and analysis material, for example to automatically critique a web site, or to identify the need/opportunity to create or modify a web site or set of sites, or to improve the flow of traffic through a web site or collection of sites.

In this connection according to the embodiments of the present invention, the system and method analyzes the effect of proposed modification or additions to the World Wide Web, prior to such modification or additions being made. In its simplest form, this amounts to computing the database of diffusion metric data as already described herein, and then computing the changes in diffusion metric information that would result, were a certain set of changes to be made. Using this, one can do things including, but not limited to, computing the solution to an optimization problem stated in terms of diffusion distances. In this way, the present invention yields methods for optimizing web-site deployment.

It is noted that current web banner ads are designed to move users from viewing a given web page X to viewing a web page Y with probability p, depending on the users profile. The present invention yields methods for replacing web advertisement with a more passive and unobtrusive means for obtaining the same result. Indeed, the diffusion metric database, augmented with contextual information as already disclosed herein, is precisely the information set that relates to the probability that a user with a given profile will go from viewing any particular web page X to another web page Y. By setting up and solving the optimization problem defined by setting this probability to any desired p, one can discover the interconnectedness of a set of new web pages or links, together with contextual informative descriptions of the pages, the introduction of which will create the desired effect that is the goal of a contemporary web advertisement.

It is noted that the above information is additionally useful in connection with statistical information about web surfing patterns (the term “web surfing” as used herein means simply the action of a user of web information, successively viewing a series of web pages by following links or by other standard means). In accordance with embodiments of the present invention, the system and method incorporates information collected by web servers that gather statistics on links followed and pages visited, perhaps augmented by so-called cookies, or other means, so as to track which users have viewed which web pages, and in what order, and at what time. In its simplest form, this information is exploited by simply weighting the metric links according to their probability of being followed to constructing the initial notion of similarity from which the diffusion data are derived.

In accordance with the embodiment of the present invention, the system and method can be used to discover models of Internet users surfing patterns obviating the need for server acquired statistics. Indeed, the contextual synopsis information, applied to web pages and clusters of pages, present a model of user profiles. Combining this with the diffusion metric structure of the present invention, and other statistical information such as demographic studies, by any means standard in the art or otherwise, yields novel models of user profiles and corresponding surfing statistics.

The present invention yields a new mode of interactive web searches: hyper-interactive web searches. In accordance with an embodiment of the present invention, a method for such searches comprises presenting the user with a first diffusion geometry based web search as described herein, and then allowing the user to characterize the results from the first search as being near or far from what the user seeks. The underlying distance data is then updated by adding this information as one or more additional coordinates in the n-tuples describing each web page, and using diffusion to propagate these values away from the explicit examples given by the user.

Alternatively or in addition, contextual synopsis data of the indicated web pages can be used to augment the search criteria. In this way, by using the new metric and/or the new search criteria, another modified search can be conducted. The process can be iterated until the user is satisfied.

The discussion in this entire section can of course be applied to searching through databases other than web site information, as will be readily seen by one skilled in the art, and as described in the following section.

In accordance with an embodiment of the present invention, a database of any sort can be analyzed in ways that are similar to the analysis of the Internet and World Wide Web described herein. In particular, a static database or file system may play the role of X, with each point of X corresponding to a file. The kernel in this case might be any measure useful for an organizational task—for example, similarity measures based on file size, date of creation, type, field values, data contents, keywords, similarity of values, or any mixture of known attributes may be used. As another example, X can be comprised of a library of music recordings, and the kernel can be comprised of features of the music recordings such as but not limited to those described herein. In this way, an embodiment of the present invention comprises a music recommendation engine with user steerable interface.

In particular, the set of files on a user's computer, hard drive, or on a network, may be automatically organized into contextual clusters at multiple scales, by the means and methods disclosed herein. This process can be augmented by user interaction, in which the process described herein for contextual information is carried out, and the user is provided with the analysis. The user can then select which automatically derived contexts are of interest, which need to be further divided, which need to be combined, and which need to be eliminated. Based on this, the process can be iterated across scales until the user is satisfied with the result.

In accordance with an embodiment of the present invention, the method and system can be used in collaborative filtering. In this application, the customers of some business or organization might play the role of X, and the kernel would be some measure of similarity of purchasing patterns. Interesting patterns among the customers and predictions of future behavior maybe be derived via the diffusion map. This observation can also be applied to similar databases such as survey results, databases of user ratings, etc.

In particular, to illustrate the collaborative filtering example, an embodiment of the present invention can proceed as detailed herein using an example wherein a business has n customers and sells m products. The system first forms a n×m matrix: M(x,y)=the number of times that customer #x has purchased product #y. Using a fast approximate nearest neighbors algorithm, the system computes a sparse n×n matrix T such that T(x1,x2) is the correlation between normalized vectors of purchases between customers x1 and x2 (i.e. correlate normalized versions of the rows x1 and x2 of the matrix M when the correlation is expected to be high, take 0 otherwise. Here, normalized can mean, for example, converting counts to fractions of the total: i.e. dividing each row by its sum prior to the inner product). Note that correlation is used simply as an example. One could also use, for example, a matrix with the value 1 for any pair of customers that have some fixed number of purchases in common, and 0 otherwise.

It is noted that one can also compute a corresponding m×m matrix, hereinafter S, from correlations, counts, or generally similarities between products that have similar sets of customers buying them. For each of the matrices T and S, the system computes the diffusion geometry and/or the multiscale diffusion geometries as described above, acting on the matrices T and S.

From this, the system obtains a low dimensional representation of the set of customers, and the set of products, such that the customers are close in the map when the preponderance of similarities between their purchase habits is close, as viewed from the context of inference from similarity of behavior of the population. Similarly, the system obtains a low dimensional map of the products, in which products are close in the map when the preponderance of similarities between their purchase histories is close, as viewed from the context of inference from similarity of behavior of the population.

Of course, at each stage of the iteration in the multiscale construction, one can use the clustering on Xᵢ, say for the customers, to put new coordinates on the set of products (i.e. one forms a new matrix M from Xᵢ of the customers to Xᵢ of the products, constructs new T and S). When one does this, one works from the new matrices T and S, and the result is a multiscale organization of the customers and a multiscale organization of the products. In accordance with an aspect of the present invention, the multiscale structure induced, say on the rows of the matrix M at a given scale in the construction, can be used to create new coordinates on the columns of the matrix. The columns can be organized in these new coordinates. Then these in turn give new coordinates on the rows, and the iteration follows. Each of these multiscale organizations will be mutually compatible because the matrix M is rewritten at each step in the algorithm to make it so.

The preceding discussion applies in cases beyond that of customers and the products that they purchase. For example, the matrix M(x,y) above could be just as well a matrix that counts the frequency of occurrence of word x in web page y. In this way, one gets a multiscale organization of words on the one hand, and a multiscale organization of the set of web documents on the other hand, and these are mutually compatible. As another example, consider a set of music files, and a set of playlists consisting of lists from this set of files. A matrix M(x,y) can be formed with M(x,y)=1 when song x is on playlist y, and 0 otherwise. Again, the matrices T and S can be formed, and compatible multiscale organizations of artists and playlists generated. The resulting multiscale structure on sets of songs will constitute a kind of automatically generated classification into genres and sub-genres. Similarly, on the playlists, one gets a kind of multiscale classification of playlists by “mood” and “sub-mood”. Yet another example of a similar embodiment consists of one in which the files on a computer are automatically organized into a hierarchy of “folders” by taking a matrix M(x,y) where x indexes, say, keywords, and y indexes documents. The multiscale structure is then an automatically generated filesystem/folder structure on the set of files. Of course, x could be some data other than keywords, as described elsewhere in this disclosure. These and other examples described herein are meant to be illustrative and not limiting and one skilled in the art will readily see variations and modifications to the same.

In certain embodiments it is helpful to use subsets of the data first; building the multiscale structure on these subsets and then classifying the larger (original) set of data according to the result. For example, in the music vs. playlist embodiment described herein, one could start with the most popular songs (or alternatively the most popular artists). After performing the procedure described herein, the system and method of the present invention generates a multiscale characterization of genres and sub-genres. Since these are coordinates on the data, they can be evaluated by linear extension on the omitted (less popular) songs or artists. In this way, the orphaned songs are classified into the hierarchy of genres and sub-genres automatically. Moreover, as new music and new playlists are added to the system, these new items are automatically classified according to genre and sub-genre in the same way.

In certain embodiments of the present invention it is helpful to throw away uninformative data points at each scale of the algorithm. For example, as described herein, it is helpful to temporarily work on subset of the data according to popularity (i.e. large values of the matrix M). In another example, when processing documents, typically so-called stop words are ignored. Stop words are simply words that are so common that they are usually ignored in standard/state of the art search systems for indexing and information retrieval.

In accordance with an embodiment of the present invention, the method and system disclosed herein can be used in network routing applications. Nodes on a general network can play the role of points in the space X and the kernel may be determined by traffic levels on the network. The diffusion map in this case can be used to guide routing of traffic on the network. In this example, it is seen that the matrix T can be taken to be any of the standard network similarity matrices. For example, node connectivity, weighted by traffic levels. The embodiment proceeds as above, and the result is a low-dimensional embedding of the network for which ordinary Euclidean distance corresponds to diffusion distance on the graph. Standard algorithms for traffic routing, network enhancement, etc, can then be applied to the diffusion mapped graph in addition to or instead of the original graph, so that results will similarly be mapped to results relevant for diffuse flow of events, resources, etc, within the graph.

In accordance with an embodiment of the present invention, the method and system can be used in imaging and hyperspectral imaging applications. In this case, each spatial (x-y) point in the scene will be a point of X and the kernel could be a distance measure computed from local spatial information (in the imaging case) or from the spectral vectors at each point. The diffusion map can be used to explore the existence of sub-manifolds within the data.

In accordance with an embodiment of the present invention, the method and system can be used in automatic learning of diagnostic or classification applications. In this case, the set X consists of a set of training data, and the kernel is any kernel that measures similarity of diagnosis or classification in the training data. The diffusion map then gives a means to classify later test data. This example is of particular interest in a hyper-interactive mode.

In accordance with an embodiment of the present invention, the method and system can be used in measured (sensor) data applications. The (continuous) data vectors which are the result of measurements by physical devices (e.g. medical instruments) or sensors can be thought of as points in a high dimensional space and that space can play the role of X as described herein. The diffusion map can be used to identify structure within the data, and such structure can be used to address statistical learning tasks such as regression.

In accordance with an exemplary embodiment of the present invention, we now consider the problem of modeling how a fire might spread over a geographic region (e.g. for forest fire control and planning). The present invention employs a geographic map (or graph) in which each site is connected to its immediate neighbors by a weighted link measuring the rate (risk) of propagation of fire between the sites. The remapping by the diffusion map reorganizes the geography so that the usual Euclidean distance between the remapped sites represents the risk of fire propagation between them. In this way, a system can be designed in accordance with an embodiment of the present invention. The system of present invention takes the possible dynamic information about local fire propagation risk as input and computes the multiscale diffusion metric. The system then displays a caricaturized map of the region, wherein distance in the display corresponds to risk of fire spreading. In accordance with an aspect of the present invention, information about the fire, such as where it is currently burning, can be superimposed on the display. Thereby, the system of the present invention provides situational awareness information about the fire in real time, which can change dynamically with time, to enable the user can assess in real time where the fire is likely to spread next. It is appreciated that the present system can compute this situational awareness information in real time and can be updated on the fly as conditions change (wind, temperature, fuel, etc.). The points affected by a fire source can be immediately identified by their physical (Euclidean) proximity in the diffusion map. The system also can be useful for simulating the effects of contemplated countermeasures, thus allowing for a new and valuable means for allocating fire fighting resources.

As shown in FIG. 2, the risk of fire propagating from B to C is greater than from B to A, since there are few paths through the bottleneck. In the diffusion geometry the two clusters are substantially far apart. This illustrates a more general point that the present invention is well suited to solving problems including but not limited to those of resource allocation, allocation of finite resources of a protective nature, and problems related to civil engineering. For example, to illustrate but not limit, consider the problem of where to place a given number of catastrophe countermeasures on the supply lines of a public utility. By using diffusion mathematics, one can use the present invention to setup and then solve the corresponding numerical optimization problem that maximizes the distance between clusters, or points within the low-pass-filtered version of the supply network (in the sense of the Coifman & Maggioni paper). As another example, given census data about places of abode and places of employment, as well other data on travel patterns of the citizens of a region, one can define diffusion metric from initial data relating to the probability of a person traveling from one location to another. Roads, as well as public transportation routes and schedules, can then all be planned so that the capacity of transport between locations is equal to the diffusion distance. These examples are of course directly applicable to problems of network traffic routing and load balancing of any kind, such as telecommunications networks, or internet services, such as those described in U.S. Pat. No. 6,665,706 and the references cited therein, each of which is incorporated by reference in its entirety.

In a search application, the sites can be viewed as digital documents which are tightly related to their immediate neighbors, the links representing the strengths of inference (or relationship) between them. The multiplicity of paths connecting a given pair of documents represents the various chains of inference, each of which carries some particular weight with the sum ranking the relation between them.

In the context of characterizing customers of a business, each customer can be viewed as a “site”, with the corresponding list of customer attributes being the digital document. In accordance with an embodiment of the present invention, the system and method only links customers whose attributes are similar, preferably very similar, in order to map out the relational structure of the customer base. Good customers are then identified by their natural proximity to known customers, and a risk level can be identified by the preponderance of links (or distance in the map) from a given customer to “dead beats”.

The concepts of text, context, consumer patterns (usage patterns), and hyper-interactive searching, as articulated above, in the context of internet web searching and indexing, all have analogs in the context of the analysis of other databases. For example, a book retailer can compute the multi-scale diffusion analysis of the database of all books for sale, using within the metric items, such as subject, keywords, user buying patterns, etc., keywords and other characteristics that are common over multiscale clusters around any particular book provide an automatic classification of the book—a context. A similar analysis can be made over the set of authors, and another similar analysis on the set of customers. In this way, new methods arise allowing the retailer to recommend unsolicited items to potential buyers (when the contexts of the book and/or author and/or subject, etc, match criteria from the derived context parameters of the customer). Of course this example is meant to be illustrative and not limiting, and this approach can be applied in a quite general context to automate or assist in the process of matching buyers with sellers.

The methods and algorithms of the present invention have application in the area of automatic organization or assembly of systems. For example, consider the task of having an automated system assemble a jigsaw puzzle. This can be accomplished by digitizing the pieces, using information about the images and the shapes of the pieces to form coordinates in any of many standard ways, using typical diffusion kernels, possibly adapted to reflection symmetries, etc., and computing diffusion distances. Then, pieces that are close in diffusion distance will be much more likely to fit together, so a search for pieces that fit can be greatly enhanced in this way. Of course, this technique is applicable to many practical automated assembly and organization tasks.

The methods and algorithms described herein have application in the area of automatic organization of data for problems related to maintenance and behavioral anomaly detection. As a simple illustration, suppose that the behavior of a set of active elements of some kind is characterized using a number of parameters. Running a diffusion metric organization on that set of parameters yields an efficient characterization of the manifold of “normal behavior”. This data can then be used to monitor active elements, watching how their behavior moves about on this normal behavior manifold, and automatically detecting anomalous behaviors. In addition, as described in the myriad of examples herein, the characterization allows for the grouping of active elements into similarity classes at different scales of resolution, which finds many applications in the organization of these active elements, as they can be “paired up” or grouped according to behavior, when such is desirable, or allocated as resources when such is desirable. In fact, this ability to group together active elements in any context, with the grouping corresponding to similarity of behavior, together with the ability to automatically represent and use this information at a range of resolutions, as disclosed herein, can be used as the basis for automated learning and knowledge extraction in a myriad of contexts.

An embodiment of the present invention relates to finding good coordinate systems and projections for surfaces and higher dimensional manifolds and related objects. Indeed, a basic observation of the present work is that the eigenvectors of Laplacian operators on the surfaces (manifolds, objects) provide exactly such. The multi-scale structures, described in the paper of Coifman & Maggioni, give precise recipes for then having a series of approximate coordinates, at different scales and different levels of granularity or resolution, as well as a method for automatically constructing a series of multi-resolution caricatures of the surfaces, manifolds, etc. There are direct applications of these ideas for representations of objects in computer aided design (CAD) systems, as well as processes for sampling and digitization of 2D and 3D objects.

An embodiment of the present invention relates to the analysis of a linear operator given as a matrix. If the columns of the matrix are viewed as vectors in R^{N}, and any standard diffusion kernel used, then the matrix can be compressed in the diffusion embedding, allowing for rapid computation with the matrix.

An aspect of the present invention relates to the automated or assisted discovery of mappings between different sets of digital documents. This is useful, for example, when one has a specific set of digital documents for which there is some amount of analytical knowledge, and one or more sets of digital documents for which there is less knowledge, but for which knowledge is sought. As a simple concrete example, consider the problem of understanding a set of documents in an unknown language, given a corresponding set of documents in a known language, where the correspondence is not known a priori. In this problem, one wants to build a “Rosetta stone.”

In an embodiment, consider two sets of digital documents, A and B. Begin by organizing A and B using any appropriate diffusion metric. Now, build two new sets of digital documents A′ and B′. For each document D in A, let S be the set of nearest neighbors of D in the diffusion embedding within some fixed radius (this radius is a parameter in the method), translated to the origin by subtracting the coordinates of D in the diffusion embedding. Now replace S with the corresponding member from an a priori fixed coset under the action of the unitary group, thus capturing just the local geometry around S. Now place a point D′ in A′, with coordinates equal to this reduced S. Alternatively, the coordinates of D′ can be taken to be the reduced S coordinates at a few different multi-scale resolutions. Next, compute B′ in the corresponding way. Now compute a diffusion mapping for C′=the union of A′ and B′. In doing so, one can use a kernel that is adapted to measure distance via something analogous to “edit distance”, which counts the number of additions and deletions of points (nearest neighbors at different scales) from one set, needed to bring the set to within some parametrically fixed distance of the other set (recalling that this distance is a distance between two sets of points), and also relates to the ordinary distance between the coordinates of the two points, or to the coordinates after the edit operation. The end result will be that two documents D1′ in A′ and D2′ in B′ will be close when a good candidate for a mapping of A to B sends D1 to D2.

In one view, the original problem can be stated as that of finding a natural function mapping between A and B, but with the added complexity that either A or B or both might be incomplete, so that one really seeks a partial mapping. It is natural to require that this mapping, where defined, be a quasi-isometry, or at least a homeomorphism. In any case, theoretically since A and B are finite, a brute-force search would yield an optimal mapping, although it would be intractable to carry out such a search directly. The procedure in the previous paragraph pre-processes the data so as to greatly reduce the cost of such a search. In practical problem for which it is possible to make progress from partial information, such as the Rosetta stone example, the process can be iterated, adjusting the metric with the partial progress information.

In accordance with an embodiment of the present invention, the method and system relates to organizing and sorting, for example in the style of the “3D” demonstration in the Coifman et al. paper. In that demonstration, the input to the algorithm was simply a randomized collection of views of the letters “3D”, and the output was a representation in the top two diffusion coordinates. These coordinates sorted the data into the relevant two parameters of pitch and yaw. Since, in general, the diffusion metric techniques disclosed herein have the power to piece together smooth objects from multi-scale patch information, it is the right tool for automated discovery of smooth morphisms (using “smooth” in a weak sense).

The present methods are applicable also for non-symmetric diffusions as discussed in the Coifman & Maggioni reference. The point being that many transitions or inferences as occurring in various applications (e.g., in web searches) are not necessarily symmetric. In general this lack of symmetry invalidates the eigenfunction method as well as the diffusion map method. The present invention overcomes these problems by building diffusion wavelets to achieve the same efficiencies in computing diffusion distances, as well as Euclidean embedding as described herewith the symmetric case. For this reason, the use of the term “diffusion map” and other similar terms herein should be taken as illustrative and not limiting, in the sense that the corresponding techniques with diffusion wavelets are more generally applicable. Any discussion herein relating to the applications of diffusion maps, etc. should be interpreted in this more general context. Similarly, fr_matr_bin-type embodiments described herein are also interchangeable with diffusion geometry and diffusion wavelet embodiments; each can be substituted for any of the others.

Many of the algorithms of the present invention scale linearly in the number of samples—i.e. all pairs of documents are encoded and displayed in order N (or, for some aspects, N log N) where N is the number of samples, allowing for real-time updating. The documents can be displayed in Euclidean space so that the Euclidean distance measures the diffusion distance. The methods of the present invention provide a data driven multiscale organization of data in which different time/scale parameters correspond to representations of the data at different levels of granularity, while preserving microscopic similarity relations.

The methods of the present invention herein provide a means for steering the diffusion processes in order to filter or avoid irrelevant data as defined by some criterion. Such steering can be implemented interactively using the display of diffusion distances provided by the embedding. This can be implemented exactly as described in the section on hyper-interactive web site searching. This method is particularly preferred in the case of expert assisted machine learning of diagnosis or classification.

Additionally, an embodiment of such techniques to steer diffusion analysis comprises of the following steps:
210: Apply the diffusion mapping algorithms in the context of a search or classification problem;
220: Provide the initial results to a user;
230: Allow the user to identify, by mouse click gestures or other means, examples of correct and incorrect results;
240: For each class in the classification problem, or for the classes “correct” and “incorrect”;
240a: Use the diffusion process to propagate these user-defined labelings from the specific data elements selected in step 230 and corresponding to the current class, for a time t, so that the labels are spread over a substantial amount of the initial dataset;
250: Collect the data vector of diffused class information (scores); and
260: Use the data vector in step 250 as additional coordinates and go to step 210.

Alternatively, the present techniques to steer diffusion analysis can comprise the following additional steps:
261: Use the data vector in step 250 to change the initial metric from which the initial diffusion process was conducted. Do this as follows:
   261.1: Label each element in the initial dataset with a “guess classification” equal to the class for which its diffused class score is the highest.
   261.2: Modify the initial metric so that connections between data elements of the same guess class are enhanced, at least slightly, for at least some elements, and/or so that connections between data elements of different guess classes are reduced, at least slightly, for at least some elements.

Alternatively, or in addition, steps 210 through 230 can be replaced by any means for allowing the user, or any other process or factor, including a priori knowledge, to label certain data elements in the initial dataset, with respect to class membership in a classification problem, or with respect to being “good” or “bad”, “hot” or “cold”, etc., with respect to some search or some desired outcome. The rest of the algorithm (steps 230-260 (or 230-261.2)) remain the same.

Alternatively, the above algorithm can be used in other aspects of the present invention described herein, modified as one skilled in the art would see fit. For example, the technique can be used for regression instead of classification, by simply labeling selected components with numerical values instead of classification data. When the different values are propagated forward by diffusion, they can be combined by averaging, or in any standard mathematical way.

Other important properties and aspects of the present invention are:
Clustering in the diffusion metric leads to robust digital document segmentation and identification of data affinities;
Differing local criteria of relevance lead to distinct geometries, thus providing a mechanism for the user to filter away unrelated information;
Self organization of digital documents can achieved through local similarity modeling, in which the top eigenfunctions of the empirical model are used to provide global organization of the given set of data;
Situational awareness of the data environment is provided by the diffusion map embedding isometrically converting the (diffusion) relational inference metric to the corresponding visualized Euclidean distance;
Searches into the data and relevance ranking can be achieved via diffusion from a reference point; and
Diffusion coordinates can easily be assigned to new data without having to recompute the map for new data streams.

In accordance with an embodiment of the present invention, items of inventory are arranged according to diffusion geometry, or are indexed by a search engine as in FIG. 1, so that when potential sales arise (e.g. advertising opportunities), elements of the inventory can be presented to the potential customer(s) according to customer profiles, context, and/or search queries. Examples include but are not limited to arrangement of inventory of visual content such as images, photos and videos, music content, text content, advertising inventory, as well as tangible inventory such as books, clothing, toys, or any merchandise.

In an embodiment of the present invention relating to displaying advertisements that are related to content and for which preferential positioning of the advertisements displayed can be determined by relevance to the context, as well as influenced by a bidding process or other economic considerations, is as follows:
Step 310: Compute diffusion geometry for a corpus of documents with appropriate choice of initial metric data that can relate to document interlinking, latent semantic index, mutual information and other methods including those standard in the art. An illustrative but non-limiting example of such a corpus would be one that has the text of a collection of web pages from one or more web sites, from one or more collaborating business, as well as, optionally, the text of a number of product advertisements that one seeks to advertise on at least some of the web pages in the corpus via banner ads or other links.
Step 320: Pre-store a data-structure that allows for the diffusion distance between any pair of documents in the corpus to be computed rapidly (e.g., the top several coordinate in the diffusion geometry).
Step 330: Optionally, pre-store a data-structure that allows one to compute the diffusion nearest neighbor documents to any document in the corpus.
Step 340: Optionally adjust the results that would be returned by steps 320 and/or 330 to favor certain listings which are economically favorable (i.e. weight by bids or by other perceived economic numerical value of the listing). A method to do this for advertisements and other similar listings would be to break the favored listings into a separate sub-corpus, and arrange the data-structure so that one can find the top nearest neighbors to any document, the neighbors being from within the whole corpus, and also find the top nearest neighbors to any document, the neighbors being from within the selected sub-corpus.
Step 350: When an advertising opportunity arises (i.e. either when one wishes to decide which ads to display, or which pages to interlink for some combination of the reasons that the content is inter-related, and/or that there is some economic motivation for linking, such as a paid advertisement), compute the nearest neighbor documents and provide listings of those documents. Present invention provides preferential placement to those listings that have the most favorable numerical scores of nearness, as modified in step 340.

An embodiment of the present invention in this aspect comprises a method for influencing a position or presence or placement of a listing within an advertising section of a rendering of a document or meta-document on a computer network, wherein text documents relating to the listing are used to characterize the listing, and the content of the document or meta-document are then matched against this text for the listing by methods further disclosed herein, in order to decide where the listing should be placed. This can incorporate the other elements described herein, such as bidding and other economic influencing of listing placement, etc.

An embodiment of the present invention consists of a system for strategic content co-management (SCcMS). By this it is meant a system that takes content from one or more sources and automatically creates and satisfies advertising opportunities by associating related content, with preferences given to economic factors using methods such as, but not limited to, the method described in the above algorithm.

As further illustration, consider a situation in which a web portal type company (coA), has a lot of online content of interest to, for example, the general public or a large special interest group. Further imagine a second such company (coB). Finally, a third company (coC), that has, for example, products and services to sell. Consider that the three companies have a mutual agreement to boost traffic mutually among their websites, and to assist in the mutual sale of products and services. Then the present invention can be applied, for example as described herein, to create, for any webpage, product or service of any of the companies, a proposed list of related web-pages, products and services from the full set of companies. Now, by factoring in the numerical economic terms and conditions of the mutual agreement, one of ordinary skill in the art will readily see that the present means and methods allow for the calculation of an optimal preferential ranking of the related items. Finally, the resulting conglomeration of web-pages, products and service listings can be rendered for display. It is one method of practice of the present invention to provide up to 3 different preferential rankings of the related content, as well as methods for, e.g., generating html or other web renderings, that allow for three different customized views of the same content, wherein the views are branded coA, coB, and coC, respectively, and wherein the rendering optionally uses the preferential ranking to decide on preferential positioning of the related items.

Another aspect of the present invention relates to steerable searching, as disclosed herein. Further details of such searches include the idea of a meta-search engine which uses ordinary search engines to return initial results of an initial query. The initial results can be given a diffusion geometry as disclosed. Users can then rate pages as being “good” or “bad” and the diffusion geometry can be used to re-order the returned results.

In accordance with an embodiment of the present invention, the method for performing a meta-search comprise the following steps:
410: Pre-compute the diffusion geometry of a first corpus of documents;
420: Provide one or more search engines to one or more users (i.e., this invention works in the context where there are search engines provided. Such provisioning is not necessarily part of the invention, although it can be);
430: Take the results of search queries and post-process them as follows:
431: Take at least some documents from the set of documents returned by a search query as a second corpus;
432: Use the diffusion map corresponding to the diffusion coordinates in step 410, to project the documents in corpus 2 (or at least an excerpt from at least some of the documents) into the “space” of corpus 1 (i.e. compute the coordinates of each document/excerpt taken from corpus 2, with respect to the diffusion mapping for corpus 1);
433: Re-sort the search results using the information from step 432, perhaps combined with some information from the initial ranking of the search results

An example of the above algorithm, meant to be illustrative and not limiting, comprises the following. Take corpus I to be at least some of the documents from a special-interest web site (e.g., mlb.com for Major League Baseball). In this way, the corpus, and it's diffusion geometry, “defines” the special interest (i.e. in the example given, the corpus defines the web for Major League Baseball, in the sense that diffusion proximity to documents in the corpus implies relevance to/for Baseball fans). Compute the diffusion geometry of this corpus, using, e.g. the mutual information or word frequency methods described herein, or any other method. Take a search engine, such as Google, that ranks pages according to, e.g., authority on the web. Take a search result from Google (corpus 2). Take at least the top N documents (top with respect to Google's ranking). Compute the projection of the “keyword in context” quote from each page, into the coordinates of the first corpus. e.g. in the case of the word frequency coordinate, compute the frequencies of relevant words, and take the appropriate linear combination of eigenfunctions or their duals, to get diffusion coordinate “proxys” for the documents in the search (which may not have been in the first corpus). Now, resort the list, putting near the top only those documents that have new coordinates close to the original documents in corpus one. One could sort the corpus two new coordinates into logarithmic bins of distance from corpus one. Then, within each bin, sort by Google rank. The results can then be displayed in the corresponding order. In this way, one sees the most relevant documents first, and sorted by “web authority” in the sense of Google, within the tiers of relevance.

Yet another aspect of the present invention relates to distributed calculation of the diffusion vectors, and pageRank. PageRank and diffusion geometry computations (hereafter features) were both originally disclosed within systems for which the relevant quantities are computed on a server or cluster of servers. This can be a lengthy process, and can require a cluster of a large number of servers for the computation to be done in a reasonable amount of time. Such clusters are expensive. Hence there is a need for a method to perform these computations and related computations without requiring a specialized server. The present invention solves this problem in the context of networked databases and document delivery systems such as the Internet, World Wide Web, and Internet email. In each of these contexts, the documents for which the features are to be computed are each handled by at least one server. As described herein, one can augment the protocols and processing in such a way that the server which is already serving the document computes the feature.

An example, meant to be illustrative and not limiting, is given as follows:
510: Augment each server on the Internet so that it stores not only its web pages, but a number which give a current estimate of the rank of each page, and also a model of the set of all web pages that link to each of its pages. The model can be empty at first, and will be dynamically updated by this algorithm. The rank number can be random at first, and is dynamically updated by this algorithm.
520: Augment HTTP with a new protocol element that, whenever requesting a web page, also serves the rank of the referring page.
530: Then, the server receiving the request has a dynamic update of the estimate of the rank of the pages that link to it. From this, it can regularly update its internal model of the pages that link to it, and it can compute, via the usual formula or any number of related formuli, its rank. One example of such a formula can be: 1/N*sum_i rank_i , where the sum is over the N pages known to link to the present page, i=1 . . . N, and rank_i is the reported rank of inlinking page i. Another useful formula would be sum_i frac_i*rank_i, where frac_i is the fraction of the time that a refer come from page i, and rank_i is the rank of page i, and the sum is from 1 . . . N, where again N is the total number of distinct pages known to link to the current page.
540: Whenever a link is “clicked on” within the current page, the HTTP request to follow that link shall forward the revised current estimate of the current pages rank, so that the receiving page can implement this algorithm.

It should be observed that one aspect of the present invention is that, while pageRank as defined by Page and Brin (See: “The Anatomy of a Large-Scale Hypertextual Web Search Engine” by Sergey Brin and Lawrence Page; <http://www-db.stanford.edu/˜backrub/google.html>) weighs all links into a page with the same weight, conditioned only by the page rank of the page, the above process has enough information to weigh the links according to the amount of traffic that flows through the link at any given time, in addition to the rank of each page. Hence a more relevant ranking of pages is computed; one that factors in not only link popularity, but usage popularity.

It should be further observed that the above algorithm computes essentially the top non-trivial eigenvector of a certain linear map (as is standard in the art, and it is intended that the above algorithm be modified with all of the usual techniques standard in the art). An embodiment of the present invention also comprising the following modification to the above algorithm: instead of computing one eigenvector, compute several (a fixed number) diffusion geometry eigenvectors, using standard iterative methods from linear algebra, augmented with the present disclosure and those items incorporated by reference. The computation can factor in not only link geometry and traffic weights, but also semantic and text processing such as standard in the art and as described herein. In this way, each web server carries at all times an estimate of the diffusion geometry coordinates of each page on the server. In an embodiment of the present invention, this algorithm need not be implemented on all servers, in that the algorithm can be restricted simply to “participating” servers. In that case, if and when a refer comes from a non-participating server, the page's rank can be updated using a default value for the referring page's rank, or by looking up some other proxy for the referring page's rank, or by ignoring the page, as if the link did not exist.

A further aspect of the present invention as it relates to distributed computation is that methods standard in the art can be used for authentication and validation of reported ranks. In particular, secure protocols, with signed certificates, etc, can be used, to detect that the servers in question have not been tampered with, either by the administrator of the server or other outside parties. It is seen that the disclosed algorithm would be otherwise potentially subject to falsification of data, which could artificially inflate a perceived rank of a page. One specific method for authentication comprises the step of randomly or systematically asking a page to not only report its rank, but report how it computed its rank (by listing those pages that linked to it, and their respective ranks). A querying application can then randomly or systematically perform a “spot check” that all or many of the reported data are correct or approximately correct (the latter since the numbers are dynamic). Servers can keep a log of reports of rank, and of the rank of pages that they link to, not just pages that link to them. In this way, such spot checks can be made even more tamper resistant. Exploits to defeat the described authentication of the present invention requires a conspiracy between a server and those servers that link to it, which is possible, but the conspiracy would have to propagate to all servers that connect to the latter servers, and so on. In accordance with an embodiment of the present invention, each server can keep a record of any “cheating” and report it as part of a protocol, or even refuse to follow links to cheaters. In addition, servers could report a “cheating index” to those servers connected to it, and the servers could cache an “honesty diffusion geometry” in addition to the above, the latter being a “relatedness diffusion geometry”. In this way, and in obviously related ways as will be readily seen by those skilled in the art, the system can be made self-policing and tamper-proof.

Yet another use for the present invention relates to applying the above technique as a means for optimizing email paths for solicited email and a means for stopping email spam (i.e. unsolicited commercial email). Indeed, each email server can keep a “traffic diffusion geometry” and a “spam diffusion geometry” for itself and for those servers from which it receives frequent email. These diffusion geometries can propagate over the Internet in a way analogous to the “honesty” and “relatedness” geometries as disclosed herein. Of course the disclosed means of traffic, interlinking and index propagation are obviously augmented by all of the methods for the same that are standard in the art.

An embodiment of the present invention can be practiced to assign diffusion coordinates to a new digital document, i.e. one that was not used to compute the diffusion geometry. Indeed, the diffusion coordinates of a digital document are, in practice, accessed by looking up the document in a pre-computed data-structure. This pre-computed structure contains information on how to map document attributes such as link structure, word frequency, mutual information, latent semantic index coordinates, and any number of other factors, into coordinates. If one encounters a new document, one can apply the map given by the data-structure, to the new document, in order to instantiate diffusion coordinates for it. Applications of the present invention include but are not limited to: deciding where within a web site to place new content; dynamically updating diffusion data; decreasing the complexity of diffusion calculations by lessening the requirements on corpus size for the pre-processing step; merging two pre-analyzed corpuses into one; and others, as will be readily seen by one skilled in the art.

An embodiment of the present invention comprises a browser, or browser toolbar, or server, or proxy server disposed as in the following example that illustrates assisted content viewing, etc, in the context of web browsing:
Step 610: provide a view of web pages, or practice the system as an improvement of an existing web browser, e.g. as a toolbar, server, or proxy server; and
Step 620: provide, as part of the view, either in another panel, a menu, a popup, or other comparable means, one or more lists of links to “related documents”. These can come from diffusion coordinates or other lists of one or more of the following types: from the user's personal preferences, from knowledge of the user's profile, from strategic content analysis as disclosed herein.

It is appreciated that in accordance with an embodiment of the present invention, the algorithm can be embodied in a form that exploits the observation of the preceding paragraph, in which coordinates can be put on new documents. That is, one can build a few sets of diffusion geometry databases, and then for example browse the World Wide Web. If a document is encountered that is in the databases, then the related links shown is the diffusion nearest neighbors, modified by any relevant filtering (e.g. the economic factors described hereinabove) (referred herein as “generalized nearest neighbors”). In the more likely case, where a viewed document is not in the databases, the coordinates of the document are computed, and the generalized nearest neighbors to the computed point are shown as the related links.

In accordance with an embodiment of the present invention, the application of the system and method can include automatically advertising within web pages, serving advertisements that are optimally, or nearly optimally related to the user's profile and to what the user is currently doing, and as usual conditioned by bids and other economic factors, as well as automatically assisting the user with a “super browser” that actively monitors the user's likes, dislikes, browsing history, etc, and uses diffusion mathematics or other standard methods to associate content that will improve the user's experience.

It is appreciated that while an aspect of many elements of the present invention is that diffusion mathematics yields a means of accomplishing tasks in the area of finding, associating and otherwise managing related content, it is also the case that many of the methods and techniques of the present invention can be practiced to extend the current searching, keyword matching or similarity measuring techniques. In accordance with an embodiment of the present invention, the system and method comprises the following algorithm:
Step 710: Compute a measure of similarity, based on keywords, for a corpus of documents, using methods including those standard in the art. An illustrative but non-limiting example of such a corpus would be one that has the text of a collection of web pages from one or more web sites, from one or more collaborating business, as well as, optionally, the text of a number of product advertisements that one seeks to advertise on at least some of the web pages in the corpus via banner ads or other links.
Step 720: Pre-store a data-structure that allows for the similarity between any pair of documents in the corpus to be computed rapidly.
Step 730: Optionally pre-store a data-structure that allows one to compute the nearest neighbor documents to any document in the corpus.
Step 740: Optionally adjust the results that would be returned by steps 720 and/or 730 to favor certain listings which are economically favorable (i.e. weight by bids or by other perceived economic numerical value of the listing). Preferable for advertisements and other similar listings, a system and method of the present invention can break the favored listings into a separate sub-corpus, and arrange the data-structure so that one can find the top nearest neighbors to any document. The neighbors located within the whole corpus. Also the system and method of the present invention finds the top nearest neighbors to any document, the neighbors being from within the selected sub-corpus.
Step 750: When an advertising opportunity arises (i.e. either when one wishes to decide which ads to display, or which pages to interlink for some combination of the reasons that the content is inter-related, and/or that there is some economic motivation for linking, such as a paid advertisement), the method and system of the present invention computes the nearest neighbor documents and provides listings of those documents. The present system and method can provide preferential placement to those listings that have the most favorable numerical scores of nearness, as modified in step 740.

The following description gives some further details of an embodiment of the present invention, it is meant to be illustrative and not limiting. A system for computing the diffusion geometry of a corpus of documents comprises the following components (Part A):
A1) data source(s);
A2) (optional) data filter(s);
A3) initial coordinatization;
A4) (optional) nearest neighbor pre-processing and/or other sparsification of the next step;
A5) initial metric matrix calculation component (weighted so that the top eigenvalue is 1)
A6) (optional) decomposition of matrix into blocks corresponding to higher-multiplicity of eigenvalue 1.
A7) computation of top eigenvalues and eigenfunctions of the matrix from step A5; and
A8) projection of initial data onto the top coordinates.

Then, when one needs to compute the distance between two documents, the system of present invention performs the following steps (part B):
B1) Choose a value of the time parameter t, by empirical, arbitrary, heuristic, analytical or algorithmic means.
B2) The distance between document X and Y is the sum of (lambda_i)ˆt*(x_i−y_i)ˆ2 (where i denotes subscript i, lambda_i is eigenvalue number i from step A7 above (in descending order), * denotes multiplication, ˆ denotes exponentiation, x_i is the diffusion coordinates of X and y_i those of Y (ordered in the same order as the eigenvalues)

In accordance with an embodiment of the present invention, the system can be used in an application, for example as follow (part C):
C1. use Part A to gather and compute the diffusion geometry of a set of web pages;
C2. for each given page in the set of pages, use part B to find those pages in the set that are closest to the given page;
C3. optionally, pre-compute the top few closest pages to each page in the set; and
C4. provide a browser, plug-in, proxy or content management, which, when rendering a web page, automatically inserts links to related pages, based on the metric information from C2 and C3.

As further illustration, the data sources in step A1 above can be a collection of web pages from a content management database or from a web crawler or web spider as is standard in the art. Step A2 could consists of a set of perl scripts, lexical analysis code in the C “lex” extension, and other tools standard in the art or otherwise, for cannonicalizing the input web pages (e.g. deleting web tags, javascript, css, comments, etc, correcting spelling errors, stemming, removal of stop words, etc), as is standing in the art or otherwise. Step A3 can be based on the computation of word frequencies for each document in the corpus (i.e. the words in the language (or at least those that occur in the corpus) index the coordinate axes, and the coordinates of each document are the frequencies of occurrence of each word in the language. One can modify this computation to use, e.g., mutual information as is standard in the art, or weighted/penalized mutual information (see, e.g., Lin, D. 1998b, Automatic Retrieval and Clustering of Similar Words, in Proceedings of COLING-ACL98, pp. 768-774, Montreal, Canada and other citations by that author and the references in his papers), each of which are incorporated by reference in its entirety. Steps A4 and A5 can comprise estimating the nearest neighbors by techniques standard in the art, and then computing correlations between vectors, thresholded if below some cutoff. In this way, a sparse matrix W results. Now, let D be the matrix with non-zero entries only on the diagonal, and these entries, D_j, j==1 . . . N, where N is the number of rows of W, with D_j being one divided by the square root of the sum of the row j of W (set this to 0 wherever the denominator in the preceding sentence is 0). Let F=D*W*D, and let A=(F+F′)/2 (where prime denotes matrix transpose). This matrix A is the example of a matrix for step A5 above. One then performs the rest of the steps as is standard to one skilled in the art of numerical linear algebra.

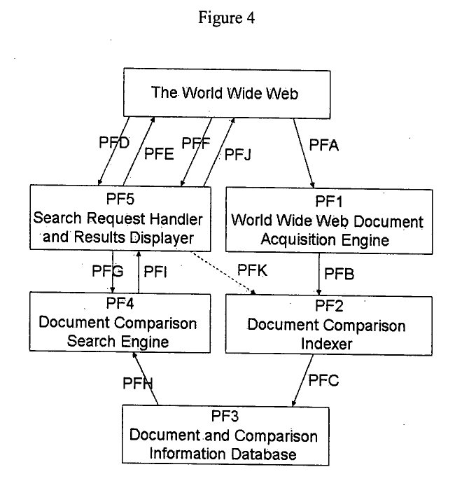

As shown in FIG. 4, another illustrative embodiment of an aspect of the present invention is found in the Public Find Similar Document Internet Utility, which enables people to find documents on the World Wide Web that are similar to a particular document appearing in their web browser.

For example, a web page about 18th century French Literature would have a hyperlink on the bottom of the page that says “Find Similar Documents”. This hyperlink forwards the user's web browser to the Public Find Similar Document Internet Utility and it, in turn displays a summary list of documents similar to the one about 18th century French Literature available on the web. The titles of each document on the list would be a hyperlink and forward the user to the document itself.

The Public Find Similar Document Internet Utility consists of 5 parts:
PF1. World Wide Web Document Acquisition Engine, also known as a “spider”;
PF2. Document Comparison Indexer;
PF3. Document and Comparison Information Database;
PF4. Document Comparison Search Engine; and
PF5. Search Request Handler and Results Displayer.

The first step is for the Public Find Similar Document Internet Utility to acquire documents from the World Wide Web. This is done by using the World Wide Web Document Acquisition Engine (PF1) to acquire documents (PFA). The documents are communicated (PFB) to the Document Comparison Indexer (PF2). The Document Comparison Indexer (PF2) analyses the documents in such a manner to enable document comparison at a later point. The information resulting from the analysis and any another required data from the document, such as the document's title and source location, also known as the URI, is communicated (PFC) to the Document and Comparison Information Database (PF3).

On completion of this first step, the Public Find Similar Document Internet Utility can now respond to “ad hoc” requests for finding similar documents. This process is initiated by a computer user clicking on a hyperlink on a web page that forwards the user's web browser to the Public Find Similar Document Internet Utility. The user's web browser communicates (PFD) to the Search Request Handler and Results Displayer (PF5) that the user would like to see similar documents to the one the user was just viewing. Within the communication (PFD) is information regarding the location, also known as URI, of the document the user was just viewing. This information is called the “referrer” described in HTTP/1.1 RFC 2616 14.36. The Search Request Handler and Results Displayer (PF5) retrieves the document the user was just viewing (PFE and F) by use of the received URI, and communicates (PFG) that document to the Document Comparison Search Engine (PF4). The Document Comparison Search Engine reads data (PFH) from the Document and Comparison Information Database (PF3) and finds similar documents to the document the user was just viewing. The Document Comparison Search Engine (PF4) communicates (PFI) data regarding the list of similar documents to the Search Request Handler and Results Displayer (PF5). The Search Request Handler and Results Displayer formats the data such that it will can be easily viewed and understood by the user. The Search Request Handler and Results Displayer then communicates (PFJ) the list of similar documents to the user.

Once the Public Find Similar Document Internet Utility has been seeded with enough documents, by use of the World Wide Web Document Acquisition Engine (PF1) to make the Public Find Similar Document Internet Utility useful, the World Wide Web Document Acquisition Engine (PF1) is no longer be needed to update the pool of documents. Instead the Search Request Handler and Results Displayer (PF5) can update the pool of documents by communicating (PFK) the document retrieved (PFE and PFF), after users request documents similar to the one they are viewing, to the Document Comparison Indexer (PF2). The Public Find Similar Document Internet Utility can also count the number and frequency of request by users to retrieve similar documents of particular documents they were viewing. This information can be used for similar document list ranking or general statistical purposes.

The Public Find Similar Document Internet Utility can retrieve documents based on the comparison of entire documents instead of a small set of keywords. The Public Find Similar Document Internet Utility also only requires one click of a computer mouse to find similar documents to the one they are viewing, as opposed to current World Wide Web search engines which would require the user to pick out a few relevant keywords from the document and type or cut and paste them into the search box of a current World Wide Web search engine. In accordance with an exemplary embodiment of the present invention, data points can be taken to each be a series of numbers and can thus be viewed as vectors in high dimension Euclidean space. This restriction is for illustrative and not limiting purposes. Indeed, one of ordinary skill in the art will be familiar with the conversion of other data to numerical data. Examples of data for which the present invention can be applied include but are not limited to responses to a questionnaire or poll, such as those in which a product or series of products is rated, and yes/no psychological profiles.

For example, in the case of a questionnaire, the digital data points are taken to be vectors in high dimensional Euclidean space, wherein each coordinate is a response to one question. Examples of tasks to be considered include, but are not limited to, that of shortening the questionnaire by eliminating some questions and later filling in the expected response; validating the responses to questionnaires by using the present invention as a non-linear consistency check on responses; or generally filling in missing data that was originally omitted from the response to the questionnaire or otherwise lost. As used herein, the phrase “missing data needs to be filled in” means that the present invention needs to estimate the correct answers to the questions in the situation in which the correct answer is not available, or is suppressed. The missing data inference is based on the similarity or affinity of the responses to other questions, by a given person, to the responses of other people with similar response profile.

The present invention relates in part to the use of diffusion geometry as disclosed herein. Diffusion geometry enables the definition of affinities between data points. Moreover it enables the organization of the population of responders into “affinity folders” or subsets with a high level of affinity among their members. Moreover the same method allows for the organization of questions into “affinity folders” of questions having highly related responses. The response to meta-questions (aggregates of highly related questions) are added to the questionnaire as a means to improve the aggregation of responders into “affinity folders”, while at the same time the present invention augments the population of responders by adding the meta-responses (i.e. the average response of an affinity folder of people). The multiscale data matrix thus augmented is an object on which analysis is performed in accordance with some embodiments of the present invention. These embodiments achieve data denoising and enable robust empirical functional regression. The present invention applies to any matrix of data by building a joint inference structure combining the affinities between the columns of the matrix with the affinity structure of the rows of data. The data itself is then viewed as a function on the combined inference structure (the product of the two affinity graphs) and is approximated using the methodologies and tools disclosed herein.

As used herein, the term ‘folder’ sometimes means “a set,” in which case it is meant in part to convey a set as represented by a data-structure in such a way that the set is a collection of other objects or sets as part of a multi-scale construction. This is analogous to the way in which an ordinary “file system folder” (in operating-system jargon) can contain references to files as well as other folders—hence a multi-scale data structure of the kind we are discussing. However, use of the term folder herein is not meant to be restricted to sets of references to computer files.

In more generality, a “folder” as used herein in practicing certain embodiments of the present invention, can be a weighting function on a set of objects. This is meant to indicate the weighted presence of an object within a set. “Weighted presence” can be, for example, a probability of being in a set, or it could indicate, for example, distance from the centroid of the set. In some embodiments, such functions can also take on negative values—an indication that the object in question is not in the set, with a weight. To be precise then, a “folder” in some embodiments of the present invention is comprised of a numerical function with domain a set of objects—these objects can include other folders as well as objects of interest in the embodiment.

As an example consider a data base of movie ratings by different viewers, in which each viewer rates 50 movies (e.g. as “good” or “bad”) out of a list of 10,000 movies. In order to organize the viewers into affinity groups of viewers with similar taste, we can correlate the two lists to each other, this correlation however is not very informative since we can only compare those entries that were rated by both viewers, these movie entries are most likely quite different.

In accordance with an exemplary embodiment of the present invention, the inventive method comprises the step of providing common comparison entries, by augmenting the viewer profile by assigning a score to each movie category (such as action, romance, adventure, etc.) as the average rating of movies, scored by the viewer, in that category.

In such exemplary embodiments, the categories themselves can be augmented by data driven categories in which movies which have been scored similarly by many viewers are defined as neighbors on the “movie affinity graph”, the various groupings obtained at different diffusion scales (as described in the cited patents on diffusion geometry) form movie folders or “meta categories” and can be used to add group scores to the list of scores of a viewer. Once the list of scores has been augmented by movie categories scores, it is much easier to compare the affinity in tastes between viewers, resulting in an affinity graph of viewers. The various affinity groups of viewers can then be used to assign to an individual movie a rating by subpopulations of viewers with similar tastes.

The augmented movie ratings are then used to reorganize the movies in categories.

The resulting augmented structure is a more robust movie rating data matrix with more robust affinity graph of users and movies. This pre processed data matrix can be used as the base for further inference analysis of the data as described below.

While the data discussed herein consists of responses to a questionnaire, it will be understood by one skilled in the art that any digital data set, such as the output of a sensor array, can be processed in the same way. In this way, the present invention provides data denoising and enables robust empirical functional regression for any kind of data.

In diffusion geometry as disclosed herein, the construction of basis functions such as eigenfunctions or wavelets are such that they can be extended outside the original data set. The geometric harmonics approaches in Lafon et al, indicate several procedures. By expanding an empirical function known on a partial set of data in terms of these basic functions, we can estimate the values of this function for new data points. It is an aspect of the present invention to fill in missing data by expanding the function consisting of the known data, and extending the function evaluation in this way onto points where the data is not known.

In an aspect of the present invention, the data matrix is represented as, and can be viewed as, a function on the tensor product of the graph built from the columns of the (augmented) data with the graph of the rows of the (augmented) data. In other words the original data matrix becomes a function of the joint inference structure (Tensor Graph), and can be expanded in terms of any basis functions on this joint structure, as described herein. As is well known any basis on the column graph can be tensored with a basis on the row graph, but other combined wavelet bases can also be obtained as has been done in the field of image analysis.

As seen above we are using the rows and columns of the data to build two graphs which are then merged to a single combined structure, this procedure can be done for any two graphs permitting a merge of two different structures (for example, viewers and movies).

In another aspect of the present invention heterogeneous data are fused into a single data structure. This enables blending two independent streams of data, such as two questionnaires in which a subset of individuals have responded to both, into a single combined structure in which the missing data is inferred. This is done in accordance with an exemplary embodiment of the present invention by combining the two questionnaires into a single long questionnaire, and combining the graph of individuals into a single graph using the common individuals as anchors. This combined structure is processed as above into affinity groups of individuals, and folders of related questions.

In another aspect of the present invention, the data matrix is modified (“cleaned”) to provide more consistency between the various entries. In this aspect, any original data that is far from being consistent (in a sense made precise herein), is automatically labeled an anomaly.

An algorithm in accordance with an exemplary embodiment of the present invention will now be described:

Given data entries d(q, r), where, for illustration we will take the rows q to be questions and the columns r to be responses by different individuals.
1) Organize all responders into affinity folders of individuals with similar response profile. For example, perform one step in the construction of diffusion wavelets as described herein and take the supports of the resulting diffusion wavelets at a fixed scale to be folders of responders (or affinity groups of responders).
2) Similarly organize the questions into folder of related questions were the relation affinity between questions is given be the diffusion geometry of the row graph of questions
3) Augment the data matrix by filling in the entries corresponding to each folder of questions as well as each affinity folder of individuals.
4) Build the new graph Q of augmented rows ,and the new graph R of augmented columns.
5) Expand the extended function d(q,r) in terms of the tensor product wavelet basis of the Q×R graph. A wavelet coefficient is computed by averaging on the support of tensor wavelet and validating the answer by a randomized average (or similar method) only validated coefficients are then used to reconstruct the filtered complete inferred version D(q,r) of d(q,r)) where:

$$D ( q , r ) = {\sum }_{α , β} {δ}_{α , β} {ϕ}_{α} ( q ) {φ}_{β} ( r ) ,$$

φ_{α} is a wavelet basis on Q, and φ_{β}(r) is a wavelet basis on R.

In the formula above,

$${δ}_{α , β} ≅ {\sum }_{q , r} d ( q , r ) {ϕ}_{α} ( q ) {φ}_{β} ( r ) ,$$

where the present invention accepts this sum (validate) only if various randomized averages using subsamples of our data lead to the same value of δ_{α,β}. In the calculation of D, the present invention only uses accepted estimates for δ_{α,β}.

The wavelet basis can of course be replaced by tensor products of scaling functions or any other approximation method in the tensor product space, including other pairs of bases, one for q the other for r, including but not limited to graph Laplacian eigenfunctions.

In accordance with an exemplary embodiment of the present invention, a direct method for estimating D without the need to build basis functions can be implemented as follows. Define a Markov matrix A=a{(r,q),(r″,q″)} (corresponding to diffusion on Q×R as:

$$a \{ ( r , q ) , ( {r}^{″} , {q}^{″} ) \} = \frac{exp ( - [ {( v ( r ) - v ( {r}^{″} ) )}^{2} / ɛ + {( μ ( q ) - μ ( {q}^{″} ) )}^{2} / δ ] )}{{\sum }_{{r}^{″} , {q}^{″}} exp ( - [ {( v ( r ) - v ( {r}^{″} ) )}^{2} / ɛ + {( μ ( q ) - μ ( {q}^{″} ) )}^{2} / δ ] )}$$

Where the vector v(r) is an augmented response column vector corresponding to the column r, and μ(q) is an augmented question vector corresponding to the row question q. The parameters ε and δ are chosen after randomized validation as described herein.

An alternate definition of D in accordance with an exemplary embodiment of the present invention as follows:
D(r,q)=Σ_{r″,q″}a{(r,q), (r″,q″)}d(r″,q″).

It is noted that the distances occurring in the exponent can be replaced by any convenient notion of distance or dissimilarities, and that any polynomial in A can be used to obtain a filtering operation on the raw data.

A new combined graph can also be formed by embedding the graph Q×R into Euclidean space, for example by the diffusion embedding, followed by an expansion of the data d(q,r) on this new structure, or by filtering as above on the new structure.

In accordance with an exemplary embodiment of the present invention, a projection pursuit type approximation or any other method as used in conventional wavelet analysis and image processing can be used by viewing the data matrix d(q,r) as an image intensity where each point (q,r) is a pixel.

One skilled in the art will see that the methods disclosed herein can be used in exactly the same way to infer missing data in any partially filled data matrix. Similarly, empirical functions learned on a partial data set can be computed off the known data set for new incoming data, thereby enabling prediction and diagnostics. That is, an empirical function can always be viewed as partially known data whose entries need to be added, and so the methods apply as described.

In some exemplary embodiments, the present invention is used to combine two different response matrices into a single structure. Specifically this can be done in the case where there is at least some overlap in the questions and/or the population between the two response matrices. For example, if columns of the two matrices represent responses of the same population, then the embodiment applies. In these exemplary embodiments, one simply builds the graph for the two matrices as described herein, and then builds a third combined graph from the diffusion coordinates of the initial graphs.

Moreover, the exemplary embodiments described herein can be used to map one data matrix onto another, in which some rows (or columns) are known to correspond to each other in that they contain data that relates to the same corresponding subjects. In particular, as the previous paragraph explains, the present invention can view the response of the same questionnaire at two different times by the same populations, or slightly different populations, and map out the second response configuration onto the configuration of the first thereby identifying unpredictable or anomalous responses. More generally, the exemplary embodiment described herein applies to any set of data matrices wherein there is at least a partial known correspondence between at least some of the rows, and/or some of the columns between the various matrices.

In some exemplary embodiments, when data matrices are very sparse, or in particular when they corresponds to graphs that are not connected, the data can be pre-processed by the method of filling in empirical functions as described herein, to produce “multi-scale” features on rows and columns. Specifically, the filled in data is analogous to multiscale wavelet-smoothed versions of the original data, as in ordinary wavelet analysis. These smoothed versions are added as additional rows and/or columns of the matrix, to provide a meta-data matrix for inference.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for inferring/estimating missing values in a data matrix d(q, r) having a plurality of rows and columns, comprising the steps of:
organizing said columns of said data matrix d(q, r) into affinity folders of columns with similar data profile;
organizing said rows of said data matrix d(q, r) into affinity folders of rows with similar data profile;
forming a graph Q of augmented rows and a graph R of augmented columns by similarity or correlation of common entries; and
expanding said data matrix d(q, r) in terms of an orthogonal basis of a graph Q×R to infer/estimate said missing values in said data matrix d(q, r).

2. The method of claim 1, wherein said data matrix d(q, r) comprises questionnaire data; and further comprising the step of filling in an unknown response to a questionnaire, to infer/estimate missing values in said data matrix d(q, r).

3. The method of claim 1, wherein the step of expanding comprises the step of expanding said data matrix d(q, r) in terms of a tensor product of wavelet bases for graphs Q and R.

4. The method of claim 3, wherein the step of expanding comprises the steps of, for each tensor wavelet in basis, computing a wavelet coefficient by averaging on the support of said tensor wavelet and retaining said coefficient in the expansion only if validated by a randomized average.

5. The method of claim 1, wherein at least one of the steps of organizing comprises the steps of constructing diffusion wavelets and taking supports of the resulting diffusion wavelets at a fixed scale on said columns of said graph R.

6. The method of claim 1, wherein said data matrix d(q, r) comprises initial customer preference data; and further comprising the step of predicting additional customer preferences from said data matrix d(q, r).

7. The method of claim 1, wherein said data matrix d(q, r) comprises measured values of an empirical function f(q, r); and further comprising the step of nonlinear regression modeling of said empirical function f(q, r).

8. The method of claim 1, wherein said data matrix d(q, r) is a questionnaire d(q, r); and further comprising the steps of determining whether a response (q₀, r₀) to said questionnaire d(q, r) is an anomalous response.

9. The method of claim 8, wherein the step of determining further comprises the steps of:
generating a dataset d1(q, r) comprising responses to said questionnaire d(q, r);
omitting said response (q₀, r₀) from said dataset d1(q, r);
reconstructing said missing response (q₀, r₀) from said dataset d1(q, r) to provide a reconstructed value;
comparing said reconstructed value to said response (q₀, r₀); and
determining said response (q₀, r₀) to be anomalous when a distance between said reconstructed value and said response (q₀, r₀) is larger than a pre-determined threshold.

10. The method of claim 9, wherein said data matrix d(q, r) comprises data relevant to fraud or deception; and further comprising the step of detecting fraud or deception from said data matrix d(q, r).

11. A computer readable medium comprising code for inferring/estimating missing values in a data matrix d(q, r) having a plurality of rows and columns, said code comprising instructions for:
organizing said columns of said data matrix d(q, r) into affinity folders of columns with similar data profile;
organizing said rows of said data matrix d(q, r) into affinity folders of rows with similar data profile;
forming a graph Q of augmented rows and a graph R of augmented columns by similarity or correlation of common entries; and
expanding said data matrix d(q, r) in terms of an orthogonal basis of a graph Q×R to infer/estimate said missing values in said data matrix d(q, r).

12. The computer readable medium of claim 11, wherein said data matrix d(q, r) comprises questionnaire data; and wherein said code further comprises instructions for filling in an unknown response to a questionnaire, to infer/estimate missing values in said data matrix d(q, r).

13. The computer readable medium of claim 11, wherein said code further comprises instructions for expanding said data matrix d(q, r) in terms of a tensor product of wavelet bases for graphs Q and R.

14. The computer readable medium of claim 13, wherein, for each tensor wavelet in basis, said code further comprises instructions for computing a wavelet coefficient by averaging on the support of said tensor wavelet and retaining said coefficient in the expansion only if validated by a randomized average.

15. The computer readable medium of claim 11, wherein said code for organizing either said rows or said column further comprises instructions for constructing diffusion wavelets and taking supports of the resulting diffusion wavelets at a fixed scale on said columns of said graph R.

16. The computer readable medium of claim 11, wherein said data matrix d(q, r) comprises initial customer preference data; and wherein said code further comprises instructions for predicting additional customer preferences from said data matrix d(q, r).

17. The computer readable medium of claim 11, wherein said data matrix d(q, r) comprises measured values of an empirical function f(q, r); and wherein said code further comprises instructions for nonlinear regression modeling of said empirical function f(q, r).

18. The computer readable medium of claim 11, wherein said data matrix d(q, r) is a questionnaire d(q, r); and wherein said code further comprises instructions for determining whether a response (q₀, r₀) to said questionnaire d(q, r) is an anomalous response.

19. The computer readable medium of claim 18, wherein said code further comprises instructions for:
generating a dataset d1(q, r) comprising responses to said questionnaire d(q, r);
omitting said response (q₀, r₀) from said dataset d1(q, r);
reconstructing said missing response (q₀, r₀) from said dataset d1(q, r) to provide a reconstructed value;
comparing said reconstructed value to said response (q₀, r₀); and
determining said response (q₀, r₀) to be anomalous when a distance between said reconstructed value and said response (q₀, r₀) is larger than a pre-determined threshold.

20. The computer readable medium of claim 19, wherein said data matrix d(q, r) comprises data relevant to fraud or deception; and wherein said code further comprises instructions for detecting fraud or deception from said data matrix d(q, r).
